(19) United States
(12) Patent Application Publication
(10) Pub. No.: US 2008/0287640 A1
(43) Pub. Date: Nov. 20, 2008

(54) PROCESS FOR THE PRODUCTION OF POLYCARBONATE USING AN ESTER SUBSTITUTED DIARYL CARBONATE

(75) Inventors: Hatem Belfadhel, Roosendaal (NL); Hans-Peter Brack, Herrliberg (CH); Ignacio Vic Fernandez, Madrid (ES); Jorge Garcia Agudo, Murcia (ES); Joris de Grooth, Enschede (NL); Gerardo Hidalgo Llinas, Murcia (ES); Patrick Joseph McCloskey, Watervliet, NY (US); Louis Obando, Eagle Ville, PA (US); Martin Herke Oyevaar, Goes (NL); Laurus van der Wekke, Rucphen (NL); Dennis Willemse, Standdaarbuiten (NL)

Correspondence Address: Marina Larson & Associates LLC;re: lexan, PO BOX 4928, DILLON, CO, 80435, US

(73) Assignee: General Electric Company, Schenectady, NY (US)

(21) Appl. No.: 11/748,951

(22) Filed: May 15, 2007

(51) Int. Cl. C08G 64/04; C08G 64/30

(52) U.S. Cl. 528/207; 528/425

(57) ABSTRACT

A method of preparing polycarbonate includes a steps of providing a melt reaction mixture and allowing the melt reaction mixture to react to build molecular weight, thereby preparing the polycarbonate. The melt reaction mixture has a dihydroxy compound, an ester substituted diaryl carbonate mixture, and a melt transesterification catalyst where the ester substituted diaryl carbonate mixture may contain acid-substituted phenol. The method also includes the step of adjusting the molar ratio of acid-substituted phenol, if present, to melt transesterification catalyst (acid-substituted phenol/catalyst) in the melt reaction mixture to an amount of less than 10.

### BACKGROUND OF INVENTION

The present invention relates to polycarbonates and to a method of preparing same. Polycarbonates are generally produced through one of two types of processes: an interfacial process or a melt transesterification process. In the melt transesterification process, dihydroxy compounds such as bisphenol A are reacted with carbonic acid diesters. For many purposes, the carbonic acid diester may be a diaryl carbonate such as diphenyl carbonate.

It is also known to use the melt transesterification process with ester substituted diaryl carbonates. For example, U.S. Pat. No. 4,323,668, which is incorporated herein by reference, describes a polycarbonate transesterification process comprising reacting (ortho-alkoxycarbonylaryl) carbonates and a dihydric phenol under transesterification reaction conditions. In the specific examples, U.S. Pat. No. 4,323,668, which is incorporated herein by reference, makes uses of bismethylsalicylcarbonate (BMSC) as the diaryl carbonate. Use of ester substituted diaryl carbonates is also described in U.S. Pat. No. 6,420,512, U.S. Pat. No. 6,506,871, U.S. Pat. No. 6,548,623, U.S. Pat. No. 6,790,929, U.S. Pat. No. 6,518,391, US Application Serial No. 2003/0139529, and US Application Serial No. 2003/0149223 all of which are incorporated herein by reference.

### SUMMARY OF INVENTION

The inventors have now found that an acid-substituted phenol (e.g. salicylic acid) can lead to process instability in the melt formation of polycarbonate using the ester substituted diaryl carbonate as a carbonate source. In one embodiment the present invention provides a method of forming polycarbonate wherein the method comprises the steps of:
(a) providing a first ester substituted diaryl carbonate mixture comprising an ester substituted diaryl carbonate, wherein said first ester substituted diaryl carbonate mixture may contain acid-substituted phenol,
(b) treating the first ester substituted diaryl carbonate mixture to reduce the level of acid-substituted phenol, if present, to an amount of less than 100 ppm, thereby creating a second ester substituted diaryl carbonate mixture,
(c) forming a melt reaction mixture comprising the second ester substituted diaryl carbonate mixture, a dihydroxy compound, and a melt transesterification catalyst,
(d) allowing the melt reaction mixture to react to build molecular weight, thereby preparing polycarbonate.

In another embodiment the present invention provides a method of producing polycarbonate comprising the steps of:
(a) forming a melt reaction mixture comprising an ester substituted diaryl carbonate mixture, a dihydroxy compound, and a melt transesterification catalyst, wherein:
   the ester substituted diaryl carbonate mixture may contain acid-substituted phenol and is:
      (i) tested for the presence of said acid-substituted phenol prior to forming the melt reaction mixture, and
      (ii) if said acid-substituted phenol is present, treated to reduce the level of said acid-substituted phenol to an amount of less than 100 ppm prior to forming the melt reaction mixture,
(b) allowing the melt reaction mixture to react to build molecular weight, thereby preparing a polycarbonate.

In another embodiment the present invention provides a method of producing polycarbonate comprising the steps of:
(a) forming a melt reaction mixture comprising a dihydroxy compound, an ester substituted diaryl carbonate mixture, and a melt transesterification catalyst, wherein the ester substituted diaryl carbonate mixture may contain acid-substituted phenol,
(b) determining the amount of acid-substituted phenol present in the melt reaction mixture and-adjusting the molar ratio of acid-substituted phenol to melt transesterification catalyst (acid-substituted phenol/catalyst) in the melt reaction mixture to an amount of less than 10, more preferably less than 5, still more preferably less than 2, and most preferably less than 1, and
(c) allowing the melt reaction mixture to react to build molecular weight, thereby preparing polycarbonate.

In another embodiment the present invention provides a method of preparing an ester substituted diaryl carbonate mixture suitable for use in a melt polymerization reaction, the method comprising the steps of:
(a) providing an initial ester substituted diaryl carbonate mixture comprising an ester substituted diaryl carbonate, wherein said initial ester substituted diaryl carbonate mixture contains acid-substituted phenol, if at all in an amount less than 100 ppm,
(b) measuring and adjusting, if necessary the pH of the initial ester substituted diaryl carbonate mixture to a pH of less than 11, and
(c) controlling contact of the ester substituted diaryl carbonate mixture with water, transesterification catalyst, and/or heat,
   whereby the amount of acid-substituted phenol present in the ester substituted diaryl carbonate mixture is maintained in an amount less than 100 ppm, thereby preparing an ester substituted diaryl carbonate mixture suitable for use in a melt polymerization reaction.

### BRIEF DESCRIPTION OF DRAWING

FIG. 1 is a schematic representation of an apparatus used for the reactivity testing described in the example section.

FIGS. 2 and 3 are graphical representations of results obtained in the examples.

FIG. 4 is a schematic representation of a reactor system used in the example section.

### DETAILED DESCRIPTION

The inventors have now found that an acid-substituted phenol, such as salicylic acid, can lead to process instability in the melt formation of polycarbonate using the ester substituted diaryl carbonate as a carbonate source. Without being bound by a particular mechanism, it is believed that the acid-substituted phenol negatively impacts the performance of the melt transesterification catalyst used in the melt polymerization process. The acid-substituted phenol is believed to have its greatest impact at the earlier lower temperature stage of the melt polymerization process, for example during the oligomerization stage. The present invention provides advantageous methods, inter alia, that either adjusts the level of acid-substituted phenol in the melt polymerization process or tests for the presence of acid-substituted phenol and, if necessary, adjusts the level of acid-substituted phenol in the melt polymerization process. In another embodiment a method is provided for producing an ester substituted diaryl carbonate mixture.

### Definitions

As used in the specification and claims of this application, the following definitions, should be applied:

“a”, “an”, and “the” as an antecedent refer to either the singular or plural. For example, “an aromatic dihydroxy compound” refers to either a single species of compound or a mixture of such species unless the context indicates otherwise.

“Polycarbonate” refers to polycarbonates incorporating repeat units derived from at least one dihydroxy aromatic compound and includes copolyestercarbonates, for example a polycarbonate comprising repeat units derived from resorcinol, bisphenol A, and dodecandioic acid. Nothing in the description and claims of this application should be taken as limiting the polycarbonate to only one dihydroxy residue unless the context is expressly limiting. Thus, the application encompasses copolycarbonates with residues of 2, 3, 4, or more types of dihydroxy compounds. Furthermore the term “polycarbonate” includes both oligomers (e.g. polycarbonate polymers having from 2 to 40 repeat units derived from dihydroxy compound(s)) as well as higher molecular weight polymers (e.g. those having a number average molecular weight, Mn measured relative to polystyrene (PS) standards of between 10,000 g/mol and 160,000 g/mol).

“Dihydroxy compound” refers to one component of a melt reaction mixture used in the method of the invention to make polycarbonate. The dihydroxy reaction component comprises one or more dihydroxy compounds. In addition, when the product polycarbonate is a poly(carbonate-co-ester), diacids incorporated in the melt reaction mixture are part of the dihydroxy reaction component for determining the molar ratio of the reactants.

“Base” refers to an acid scavenging agent. Non limiting example of acid scavenging agents are alkali earth hydroxides, alkali metal hydroxides such as sodium hydroxide, ammonium hydroxides, and phosphonium hydroxides.

“Acid-substituted phenol” refers to a carboxylic acid substituted phenolic compound such as salicylic acid. The content of the acid-substituted phenol is the content as extracted by water from a pulverized samples of the ester substituted diaryl carbonate mixture or a solution of the melt reaction mixture in dichloromethane and then analyzed by HPLC.

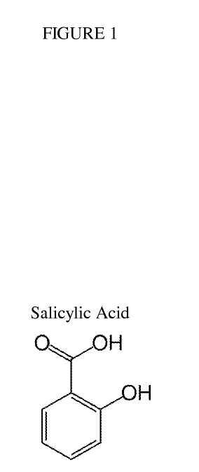

“Salicylic acid” is an example of an acid substituted phenol that may be contained in melt polymerization processes that uses ester substituted diaryl carbonate (e.g. BMSC) as a carbonate source. Salicylic acid (CAS number 69-72-7) is also know as 2-Hydroxybenzoic acid and o-hydroxybenzoic acid and has chemical formula C₇H₆O₃ (e.g. HO-C₅H₄-COOH). Salicylic acid has the structure as depicted in FIG. 1 and below:

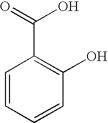

“ppm” for example when used as “ppm acid-substituted phenol” is herein understood to mean parts per million. For example 10 ppm acid-substituted phenol in ester substituted phenol or melt reaction mixture is 10 milligrams acid-substituted phenol per kg ester substituted diaryl carbonate or per kilogram melt reaction mixture, respectively. The acid-substituted phenol concentrations and levels referred to in the specification are those as measured by the HPLC method as described below.

“pH” as it is used herein to refer to a method of preparing an ester substituted diaryl carbonate mixture is herein understood to mean the pH of an aqueous extract of the ester substituted diaryl carbonate mixture at room temperature.

Numerical values in the specification and claims of this application, particularly as they relate to polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

### Materials

In the following discussion of the methods and compositions of the invention, the following materials may be employed:

A. Dihydroxy Compounds

The dihydroxy compound used in the method of the invention may be an aromatic or an aliphatic dihydroxy compound. In certain embodiments, an aromatic dihydroxy compound is preferred.

Aliphatic dihydroxy compounds that are suitably used in the present invention include without limitation butane-1,4-diol, 2,2-dimethylpropane-1,3-diol, hexane-1,6-diol, diethylene glycol, triethylene glycol, tetraethylene glycol, octaethylene glycol, dipropylene glycol, N,N-methyldiethanolamine, cyclohexane-1,3-diol, cyclohexane-1,4-diol, 1,4-dimethylolcyclohexane, p-xylene glycol, 2,2-bis(4-hydroxycyclohexyl)propane, and ethoxylated or propoxylated products of dihydric alcohols or phenols such as bis-hydroxyethyl-bisphenol A, bis-hydroxyethyl-tetrachlorobisphenol A and bis-hydroxyethyl-tetrachlorohydroquinone. Other aliphatic dihydroxy compounds include 3,9-bis(2-hydroxyethyl)-2,4,8,10-tetraoxaspiro[5.5]undecane, 3,9-bis(2-hydroxy-1,1-dimethylethyl)-2,4,8,10-tetraoxaspiro[5.5]undecane, 3,9-bis(2-hydroxy-1,1-diethylethyl)-2,4,8,10-tetraoxaspiro[5.5]-undecane, and 3,9-bis(2-hydroxy-1,1-dipropylethyl)-2,4,8,10-tetraoxaspiro[5.5]undecane.

Aromatic dihydroxy compounds that can be used in the present invention are suitably selected from the group consisting of bisphenols having structure,

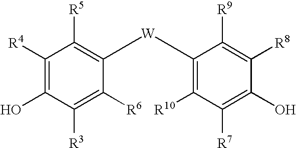

wherein R³-R₁₀ are independently a hydrogen atom, halogen atom, nitro group, cyano group, C₁-C₂₀ alkyl radical, C₄-C₂₀ cycloalkyl radical, or C₆-C₂₀ C aryl radical; W is a bond, an oxygen atom, a sulfur atom, a SO₂ group, a C₁-C₂₀ aliphatic radical, a C₆-C₂₀ aromatic radical, a C₆-C₂₀ cycloaliphatic radical, or the group

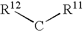

wherein R¹¹ and R¹² are independently a hydrogen atom, C₁-C₂₀ alkyl radical, C₄-C₂₀ cycloalkyl radical, or C₄-C₂₀ aryl radical; or R¹¹ and R¹² together form a C₄-C₂₀ cycloaliphatic ring which is optionally substituted by one or more C₁-C₂₀ alkyl, C₆-C₂₀ aryl, C₅-C₂₁, aralkyl, C₅-C₂₀ cycloalkyl groups, or a combination thereof; dihydroxy benzenes having structure

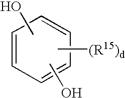

wherein R¹⁵ is independently at each occurrence a hydrogen atom, halogen atom, nitro group, cyano group, C₁-C₂₀ alkyl radical, C₄-C₂₀ cycloalkyl radical, or C₄-C₂₀ aryl radical, d is an integer from 0 to 4; and dihydroxy naphthalenes having structures

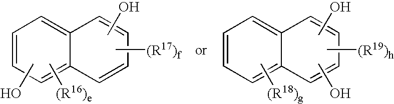

wherein R¹⁶, R¹⁷, R¹⁸ and R¹⁹ are independently at each occurrence a hydrogen atom, halogen atom, nitro group, cyano group, C₁-C₂₀ alkyl radical, C₄-C₂₀ cycloalkyl radical, or C₄-C₂₀ aryl radical; e and f are integers from 0 to 3, g is an integer from 0 to 4, and h is an integer from 0 to 2.

Suitable bisphenols are illustrated by 2,2-bis(4-hydroxyphenyl)propane (bisphenol A);
2,2-bis(3-chloro-4-hydroxyphenyl)propane; 2,2-bis(3-bromo-4-hydroxyphenyl)propane;
2,2-bis(4-hydroxy-3-methylphenyl)propane; 2,2-bis(4-hydroxy-3-isopropylphenyl)propane;
2,2-bis(3-t-butyl-4-hydroxyphenyl)propane; 2,2-bis(3-phenyl-4-hydroxyphenyl)propane;
2,2-bis(3,5-dichloro-4-hydroxyphenyl)-propane; 2,2-bis(3,5-dibromo-4-hydroxyphenyl)propane;
2,2-bis(3,5-dimethyl-4-hydroxyphenyl)propane;
2,2-bis(3-chloro-4-hydroxy-5-methylphenyl)propane;
2,2-bis(3-bromo-4-hydroxy-5-methylphenyl)propane;
2,2-bis(3-chloro-4-hydroxy-5-isopropylphenyl)propane;
2,2-bis(3-bromo-4-hydroxy-5-isopropylphenyl)propane;
2,2-bis(3-t-butyl-5-chloro-4-hydroxyphenyl)propane;
2,2-bis(3-bromo-5-t-butyl-4-hydroxyphenyl)propane;
2,2-bis(3-chloro-5-phenyl-4-hydroxyphenyl)propane;
2,2-bis(3-bromo-5-phenyl-4-hydroxyphenyl)propane;
2,2-bis(3,5-disopropyl-4-hydroxyphenyl)propane;
2,2-bis(3,5-di-t-butyl-4-hydroxyphenyl)propane; 2,2-bis(3,5-diphenyl-4-hydroxyphenyl)propane;
2,2-bis(4-hydroxy-2,3,5,6-tetrachlorophenyl)propane;
2,2-bis(4-hydroxy-2,3,5,6-tetrabromophenyl)propane;
2,2-bis(4-hydroxy-2,3,5,6-tetramethylphenyl)propane;
2,2-bis(2,6-dichloro-3,5-dimethyl-4-hydroxyphenyl)propane;
2,2-bis(2,6-dibromo-3,5-dimethyl-4-hydroxyphenyl)propane;
1,1-bis(4-hydroxyphenyl)cyclohexane; 1,1-bis(3-chloro-4-hydroxyphenyl)cyclohexane;
1,1-bis(3-bromo-4-hydroxyphenyl)cyclohexane; 1,1-bis(4-hydroxy-3-methylphenyl)cyclohexane;
1,1-bis(4-hydroxy-3-isopropylphenyl)cyclohexane;
1,1-bis(3-t-butyl-4-hydroxyphenyl)cyclohexane; 1,1-bis(3-phenyl-4-hydroxyphenyl)cyclohexane;
1,1-bis(3,5-dichloro-4-hydroxyphenyl)cyclohexane;
1,1-bis(3,5-dibromo-4-hydroxyphenyl)cyclohexane;
1,1-bis(3,5-dimethyl-4-hydroxyphenyl)cyclohexane;
1,1-bis(3-chloro-4-hydroxy-5-methylphenyl)cyclohexane;
1,1-bis(3-bromo-4-hydroxy-5-methylphenyl)cyclohexane;
1,1-bis(3-chloro-4-hydroxy-5-isopropylphenyl)cyclohexane;
1,1-bis(3-bromo-4-hydroxy-5-isopropylphenyl)cyclohexane;
1,1-bis(3-t-butyl-5-chloro-4-hydroxyphenyl)cyclohexane;
1,1-bis(3-bromo-5-t-butyl-4-hydroxyphenyl)cyclohexane;
1,1-bis(3-chloro-5-phenyl-4-hydroxyphenyl)cyclohexane;
1,1-bis(3-bromo-5-phenyl-4-hydroxyphenyl)cyclohexane;
1,1-bis(3,5-disopropyl-4-hydroxyphenyl)cyclohexane;
1,1-bis(3,5-di-t-butyl-4-hydroxyphenyl)cyclohexane;
1,1-bis(3,5-diphenyl-4-hydroxyphenyl)cyclohexane;
1,1-bis(4-hydroxy-2,3,5,6-tetrachlorophenyl)cyclohexane;
1,1-bis(4-hydroxy-2,3,5,6-tetrabromophenyl)cyclohexane;
1,1-bis(4-hydroxy-2,3,5,6-tetramethylphenyl)cyclohexane;
1,1-bis(2,6-dichloro-3,5-dimethyl-4-hydroxyphenyl)cyclohexane;
1,1-bis(2,6-dibromo-3,5-dimethyl-4-hydroxyphenyl)cyclohexane;
1,1-bis(4-hydroxyphenyl)-3,3,5-trimethylcyclohexane;
1,1-bis(3-chloro-4-hydroxyphenyl)-3,3,5-trimethylcyclohexane;
1,1-bis(3-bromo-4-hydroxyphenyl)-3,3,5-trimethylcyclohexane;
1,1-bis(4-hydroxy-3-methylphenyl)-3,3,5-trimethylcyclohexane;
1,1-bis(4-hydroxy-3-isopropylphenyl)-3,3,5-trimethylcyclohexane;
1,1-bis(3-t-butyl-4-hydroxyphenyl)-3,3,5-trimethylcyclohexane;
1,1-bis(3-phenyl-4-hydroxyphenyl)-3,3,5-trimethylcyclohexane;
1,1-bis(3,5-dichloro-4-hydroxyphenyl)-3,3,5-trimethylcyclohexane;
1,1-bis(3,5-dibromo-4-hydroxyphenyl)-3,3,5-trimethylcyclohexane;
1,1-bis(3,5-dimethyl-4-hydroxyphenyl)-3,3,5-trimethylcyclohexane;
1,1-bis(3-chloro-4-hydroxy-5-methylphenyl)-3,3,5-trimethylcyclohexane;
1,1-bis(3-bromo-4-hydroxy-5-methylphenyl)-3,3,5-trimethylcyclohexane;
1,1-bis(3-chloro-4-hydroxy-5-isopropylphenyl)-3,3,5-trimethylcyclohexane;
1,1-bis(3-bromo-4-hydroxy-5-isopropylphenyl)-3,3,5-trimethylcyclohexane;
1,1-bis(3-t-butyl-5-chloro-4-hydroxyphenyl)-3,3,5-trimethylcyclohexane;
1,1-bis(3-bromo-5-t-butyl-4-hydroxyphenyl)-3,3,5-trimethylcyclohexane;
bis(3-chloro-5-phenyl-4-hydroxyphenyl)-3,3,5-trimethylcyclohexane;
1,1-bis(3-bromo-5-phenyl-4-hydroxyphenyl)-3,3,5-trimethylcyclohexane;
1,1-bis(3,5-disopropyl-4-hydroxyphenyl)-3,3,5-trimethylcyclohexane;
1,1-bis(3,5-di-t-butyl-4-hydroxyphenyl)-3,3,5-trimethylcyclohexane;
1,1-bis(3,5-diphenyl-4-hydroxyphenyl)-3,3,5-trimethylcyclohexane;
1,1-bis(4-hydroxy-2,3,5,6-tetrachlorophenyl)-3,3,5-trimethylcyclohexane;
1,1-bis(4-hydroxy-2,3,5,6-tetrabromophenyl)-3,3,5-trimethylcyclohexane;
1,1-bis(4-hydroxy-2,3,5,6-tetramethylphenyl)-3,3,5-trimethylcyclohexane;
1,1-bis(2,6-dichloro-3,5-dimethyl-4-hydroxyphenyl)-3,3,5-trimethylcyclohexane;
1,1-bis(2,6-dibromo-3,5-dimethyl-4-hydroxyphenyl)-3,3,5-trimethylcyclohexane;
4,4′-dihydroxy-1,1-biphenyl; 4,4′-dihydroxy-3,3′-dimethyl-1,1-biphenyl;
4,4′-dihydroxy-3,3′-dioctyl-1,1-biphenyl; 4,4′-dihydroxydiphenylether;
4,4′-dihydroxydiphenylthioether; 1,3-bis(2-(4-hydroxyphenyl)-2-propyl)benzene;
1,3-bis(2-(4-hydroxy-3-methylphenyl)-2-propyl)benzene;
1,4-bis(2-(4-hydroxyphenyl)-2-propyl)benzene and
1,4-bis(2-(4-hydroxy-3-methylphenyl)-2-propyl)benzene.

Suitable dihydroxy benzenes are illustrated by hydroquinone, resorcinol, methylhydroquinone, butylhydroquinone, phenylhydroquinone, 4-phenylresorcinol and 4-methylresorcinol.

Suitable dihydroxy naphthalenes are illustrated by 2,6-dihydroxy naphthalene; 2,6-dihydroxy-3-methyl naphthalene; and 2,6-dihydroxy-3-phenyl naphthalene. Other suitable dihydroxy naphthalenes IV are illustrated by 1,4-dihydroxy naphthalene; 1,4-dihydroxy-2-methyl naphthalene; 1,4-dihydroxy-2-phenyl naphthalene and 1,3-dihydroxy naphthalene.

The relative amounts of monomers are selected based on the desired composition of the oligomers. If other comonomers are used, they can be introduced to the melt reaction system as part of the same feed, in a separate feed, or both.

The polycarbonate formed from these monomers may be a homopolymer, a copolymer, a random copolymer, or a random block copolymer. To form random block copolymers, preformed oligomer or polymer blocks with appropriate end groups (diols, diacids, diesters, etc) are used as co-reactants in the polymerization process.

Preferred dihydroxy compounds and combinations of dihydroxy compounds for use in the present invention include BPA, hydroquinone, and sulfones such as 4,4′-biphenyl sulfone.

B. Ester Substituted Diaiyl Carbonate

The ester substituted diaryl carbonates used in the methods of the present invention will preferably have the structure,

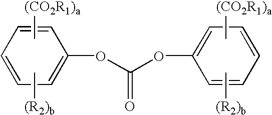

wherein R¹ is independently at each occurrence a C₁-C₂₀ alkyl radical, C₄-C₂₀ cycloalkyl radical, or C₄-C₂₀ aromatic radical; R² is independently at each occurrence a halogen atom, cyano group, nitro group, C₁-C₂₀ alkyl radical, C₄-C₂₀ cycloalkyl radical, C₄-C₂₀ aromatic radical, C₁-C₂₀ alkoxy radical, C₄-C₂₀ cycloalkoxy radical, C₄-C₂₀ aryloxy radical, C₁-C₂₀ alkylthio radical, C₄-C₂₀ cycloalkylthio radical, C₄-C₂₀ arylthio radical, C₁-C₂₀ alkylsulfinyl radical, C₄-C₂₀ cycloalkylsulfinyl radical, C₄-C₂₀ arylsulfinyl radical, C₁-C₂₀ alkylsulfonyl radical, C₄-C₂₀ cycloalkylsulfonyl radical, C₄-C₂₀ arylsulfonyl radical, C₁-C₂₀ alkoxycarbonyl radical, C₄-C₂₀ cycloalkoxycarbonyl radical, C₄-C₂₀ aryloxycarbonyl radical, C₂-C₆₀ alkylamino radical, C₆-C₆₀ cycloalkylamino radical, C₅-C₆₀ arylamino radical, C₁-C₄₀ alkylaminocarbonyl radical, C₄-C₄₀ cycloalkylaminocarbonyl radical, C₄-C₄₀ arylaminocarbonyl radical, or C₁-C₂₀ acylamino radical; a is an integer between 1 and 3 inclusive; b is an integer between 0 and 4 inclusive; and the sum of a and b for each aromatic group is less than or equal to 5.

In a preferred embodiment the ester substituted diaryl carbonate is an activated ester substituted diaryl carbonate. One method for determining whether a certain ester substituted diarylcarbonate is activated or is not activated is to carry out a model transesterification reaction between the certain diarylcarbonate with a phenol such as p-(1,1,3,3-tetramethyl)butylphenol. This phenol is preferred because it possesses only one reactive site, possesses a low of volatility and possesses a similar reactivity to bisphenol-A. The model transesterification reaction is carried out at temperatures above the melting points of the certain ester substituted diaryl carbonate and p-(1,1,3,3-tetramethyl)butylphenol and in the presence of a transesterification catalyst, which is usually an aqueous solution of sodium hydroxide or sodium phenoxide. Preferred concentrations of the transesterification catalyst are about 0.001 mole % based on the number of moles of the phenol or diarylcarbonate. And a preferred reaction temperature is 200° C. But the choice of conditions and catalyst concentration can be adjusted depending on the reactivity of the reactants and melting points of the reactants to provide a convenient reaction rate. The only limitation to reaction temperature is that the temperature must be below the degradation temperature of the reactants. Sealed tubes can be used if the reaction temperatures cause the reactants to volatilize and affect the reactant molar balance. The determination of the equilibrium concentration of reactants is accomplished through reaction sampling during the course of the reaction and then analysis of the reaction mixture using a well-know detection method to those skilled in the art such as HPLC (high pressure liquid chromatography). Particular care needs to be taken so that reaction does not continue after the sample has been removed from the reaction vessel. This is accomplished by cooling down the sample in an ice bath and by employing a reaction quenching acid such as acetic acid in the water phase of the HPLC solvent system. It may also be desirable to introduce a reaction quenching acid directly into the reaction sample in addition to cooling the reaction mixture. A preferred concentration for the acetic acid in the water phase of the HPLC solvent system is 0.05% (v/v). The equilibrium constant was determined from the concentration of the reactants and product when equilibrium is reached. Equilibrium is assumed to have been reached when the concentration of components in the reaction mixture reach a point of little or no change on sampling of the reaction mixture. The equilibrium constant can be determined from the concentration of the reactants and products at equilibrium by methods well known to those skilled in the art. An ester substituted diaryl carbonate which possesses a relative equilibrium constant (Kₜₑₛₜ/K_{DPC}) of greater than 1 is considered to possess a more favorable equilibrium than diphenylcarbonate and is an activated ester substituted diaryl carbonate, whereas an ester substituted diarylcarbonate which possesses an equilibrium constant of 1 or less is considered to possess the same or a less favorable equilibrium than diphenylcarbonate and is considered not to be an activated ester substituted diaryl carbonate. It is generally preferred to employ an activated ester substituted diaryl carbonate with very high reactivity compared to diphenylcarbonate when conducting transesterification reactions. Preferred are activated ester substituted diaryl carbonates with an equilibrium constant greater than at least 10 times that of diphenylcarbonate.

In certain embodiments the electron-withdrawing group(s) are at ortho and/or para positions relative to the carbonate substituent on the aromatic group. For example wherein the electron-withdrawing group is an ortho ester substituted.

Examples of preferred activated ester-substituted diaryl carbonates suitable for use with the present invention include bismethylsalicylcarbonate (CAS Registry No. 82091-12-1), bisethylsalicylcarbonate, bispropylsalicylcarbonate, bisbutylsalicylcarbonate, bisbenzylsalicyl carbonate, bismethyl 4-chlorosalicyl carbonate and the like. Typically bismethylsalicylcarbonate is preferred for use in melt polycarbonate synthesis due to its lower molecular weight and higher vapor pressure.

C. Acid-Substituted Phenol

The acid-substituted phenol in this invention refers to a carboxylic acid substituted phenolic compound. In one embodiment the acid-substituted phenol has the structure:

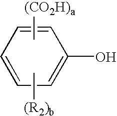

where a, R₂, and b have been described above with regard to the ester substituted diaryl carbonate. In one embodiment the acid-substituted phenol is an ortho substituted phenol.

These acidic impurities include and are not limited to salicylic acid (CAS #69-72-7), 4-hydroxybenzoic acid (CAS #99-96-7), 3-fluoro-4-hydroxybenzoic acid (CAS #350-29-8), 4-Hydroxyisophthalic acid (CAS #636-46-4), 4-Hydroxy-3-nitrobenzoic acid (CAS #616-82-0), 5-Methylsalicylic acid (CAS #89-56-5), 4-Methylsalicylic acid (CAS #50-85-1), 3-Methylsalicylic acid (CAS #83-40-9), 5-Fluorosalicylic acid (CAS #345-16-4), 3-Chlorosalicylic acid (CAS #1929-32-9), 5-Chlorosalicylic acid (CAS #321-14-2), 2-Hydroxy-5-nitrobenzoic acid (CAS #96-97-9), 3-Nitrosalicylic acid (CAS #85-38-1).

Without being bound by a particular mechanism, the inventors believe that the acid-substituted phenol may be formed by the following two-step reaction mechanism, especially at elevated temperatures:

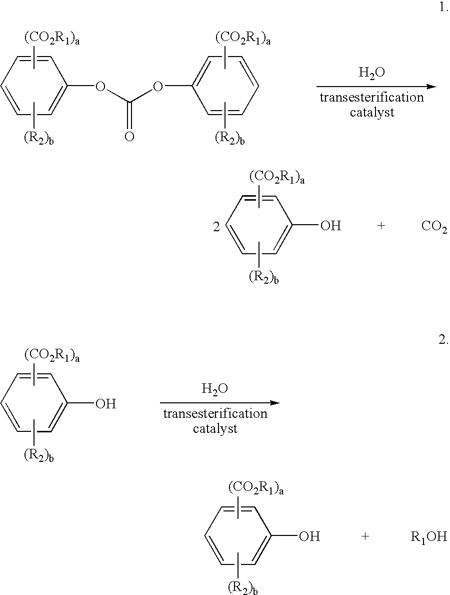

It is believed that these hydrolysis reactions that form the carboxylic acid substituted phenolic compound may proceed even at ambient temperatures, albeit more slowly than would occur at elevated temperatures. It is believed that these hydrolysis reactions proceed quite rapidly though either in solution or in the melt at temperatures above the melting point of the ester substituted diaryl carbonate (for example above about 110° C. where the ester substituted diaryl carbonate is BMSC).

As described above, in a preferred embodiment for the production of polycarbonate the ester substituted diaryl carbonate is bismethylsalicylcarbonate (BMSC). BMSC may be hydrolyzed to yield methyl salicylate and finally salicylic acid according to the following reaction scheme:

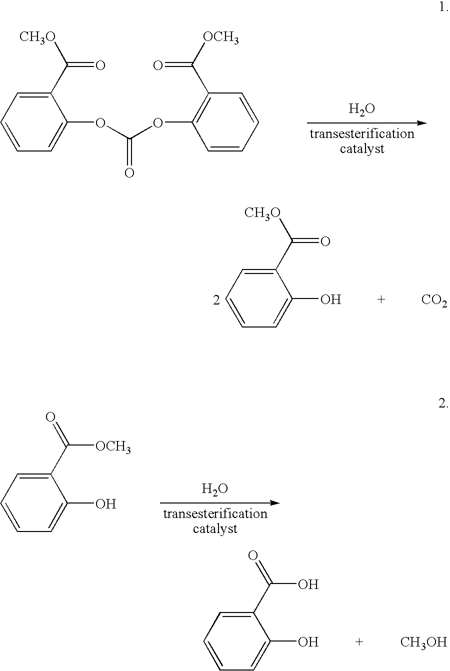

D. Melt Transesterification Catalysts

The methods of forming polycarbonate of the invention also comprise the step of introducing a melt transesterification catalyst to the melt reaction system to initiate a polymerization reaction. The melt transesterification catalyst may be introduced continuously, or may be introduced batchwise and may occur before, during or after the introduction of the dihydroxy composition or the ester substituted carbonate to the melt react system.

The melt transesterification catalyst used in the method of the present invention is a base, and preferably comprises at least one source of alkaline earth ions or alkali metal ions, and/or at least one quaternary ammonium compound, a quaternary phosphonium compound or a mixture thereof. The source of alkaline earth ions or alkali metal ions being used in an amount such that the amount of alkaline earth or alkali metal ions present in the melt reaction mixture is in a range between about 10⁻⁵ and about 10⁻⁸ moles alkaline earth or alkali metal ion per mole of dihydroxy compound employed.

The quaternary ammonium compound is selected from the group of organic ammonium compounds having the structure

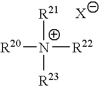

wherein R²⁰-R²³ are independently a C₁-C₂₀ alkyl radical, C₄-C₂₀ cycloalkyl radical, or a C₄-C₂₀ aryl radical; and X⁻ is an organic or inorganic anion. In one embodiment of the present invention anion X⁻ is selected from the group consisting of hydroxide, halide, carboxylate, sulfonate, sulfate, formate, carbonate, and bicarbonate.

Non-limiting examples of suitable organic ammonium compounds are tetramethyl ammonium hydroxide, tetrabutyl ammonium hydroxide, tetramethyl ammonium acetate, tetramethyl ammonium formate and tetrabutyl ammonium acetate. Tetramethyl ammonium hydroxide is often preferred.

The quaternary phosphonium compound is selected from the group of organic phosphonium compounds having the structure:

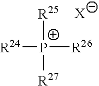

wherein R²⁴-R²⁷ are independently a C₁-C²⁰ alkyl radical, C⁴-C²⁰ cycloalkyl radical, or a C₄-C₂₀ aryl radical; and X⁻ is an organic or inorganic anion. In one embodiment of the present invention anion X⁻ is an anion selected from the group consisting of hydroxide, halide, carboxylate, sulfonate, sulfate, formate, carbonate, and bicarbonate. Suitable organic phosphonium compounds are illustrated by tetramethyl phosphonium hydroxide, tetramethyl phosphonium acetate, tetramethyl phosphonium formate, tetrabutyl phosphonium hydroxide, and tetrabutyl phosphonium acetate (TBPA). TBPA is often preferred.

Where X⁻ is a polyvalent anion such as carbonate or sulfate it is understood that the positive and negative charges in the above structures are properly balanced. For example, where R²⁰-R²³ are each methyl groups and X⁻ is carbonate, it is understood that X⁻ represents ½ (CO₃⁻²).

Suitable sources of alkaline earth ions include alkaline earth hydroxides such as magnesium hydroxide and calcium hydroxide. Suitable sources of alkali metal ions include the alkali metal hydroxides illustrated by lithium hydroxide, sodium hydroxide and potassium hydroxide. Other sources of alkaline earth and alkali metal ions include salts of carboxylic acids, such as sodium acetate and derivatives of ethylene diamine tetraacetic acid (EDTA) such as EDTA tetrasodium salt, and EDTA magnesium disodium salt. Sodium hydroxide is often preferred.

In order to achieve the formation of polycarbonate using the method of the present invention an effective amount of melt transesterification catalyst must be employed. The amount of melt transesterification catalyst employed is typically based upon the total number of moles of the total dihydroxy compounds employed in the polymerization reaction. The effective amount of catalyst will also be a function of the concentration of any acid-substituted phenol present. When referring to the molar ratio of melt transesterification catalyst, for example phosphonium salt, to all dihydroxy compounds employed in the polymerization reaction, it is convenient to refer to moles of phosphonium salt per mole of the first and second dihydroxy compounds combined, meaning the number of moles of phosphonium salt divided by the sum of the moles of each individual dihydroxy compound present in the melt reaction mixture. The amount of organic ammonium or phosphonium salts employed typically will be in a range between about 1×10⁻² and about 1×10⁻⁵, preferably between about 1×10⁻³ and about 1×10⁻⁴ moles per mole of the dihydroxy compounds combined. The inorganic metal hydroxide catalyst typically will be used in an amount corresponding to between about 1×10⁻⁴ and about 1×10⁻⁸, preferably 1×10⁻⁴ and about 1×10⁻⁷ moles of metal hydroxide per mole of the dihydroxy compounds combined.

In one embodiment the molar ratio of acid-substituted phenol to melt transesterification catalyst present in the melt reaction mixture is less than 10, more preferably less than 5, 2, or 1. The amount of melt transesterification catalyst used in calculating this ratio is the amount of melt transesterification catalyst added to the reaction mixture. In other words, low levels of catalyst species present as traces in the monomer mixture prior to melt catalyst addition are not included in the calculation of the molar ratio. One embodiment will have a molar ratio acid-substituted phenol/alkali and alkaline earth hydroxide catalyst) of less than 10, preferably less than 5, 2, or 1. Another embodiment will have a molar ratio acid-substituted phenol/(quatemary ammonium and phosphonium hydroxide catalyst) of less than 10, preferably less than 5, 2, or 1. Still another embodiment will have a molar ratio acid-substituted phenol/(sum of alkali and alkaline earth hydroxide and alkali and alkaline earth hydroxide catalyst) of less than 10, preferably less than 5, 2, or 1. This ratio levels of melt transesterification catalyst referred to in the specification are those levels of added catalyst. In other words, low levels of catalyst species present as traces in the monomeric raw materials are not considered in the calculation of this molar ratio (SA/catalyst).

### The Methods of the Invention

The present invention relates to the Inventors' discovery that an acid-substituted phenol, for example salicylic acid, can lead to process instability in the melt formation of polycarbonate using ester substituted diaryl carbonate, such as BMSC, as a carbonate source in a melt reaction mixture.

### The Acid-Substituted Phenol:

The acid-substituted phenol, if present in a melt polymerization reaction mixture, may be introduced together with the ester substituted diaryl carbonate. US Patent Publication No. No: US 2006/0025622 A1 which is incorporated herein by reference for all purposes, teaches that there are several ways of making ester substituted diaryl carbonates. In a particularly preferred method, ester substituted diaryl carbonates can be produced by forming a melt reaction mixture comprising an ester substituted phenol, such as methyl salicylate, phosgene and a catalyst. This ester substituted diaryl carbonate formation reaction takes place in a high pH and high brine (NaOH) environment. However, it has been found that the ester substituted diaryl carbonate is not stable in this high pH environment and may hydrolyze back over time to the starting ester substituted phenol or salt thereof. It is believed that under high pH conditions the ester substituted phenol and the salts of ester substituted phenols may hydrolyze to form the acid-substituted phenol.

It has also been found that carboxylic acid substituted phenols like salicylic acid may be readily formed from ester substituted diaryl carbonates after they have been produced and during its purification, transport, transfer, storage or use unless great care is used and appropriate measures are taken. For example, ester substituted diaryl carbonates are typically solids at room temperature and may often conveniently be transported and transferred in the molten or solid states. In addition, the ester substituted diaryl carbonates may often readily be purified at elevated temperatures by vacuum distillation processes. It has been surprisingly found that the ester substituted diaryl carbonates are quite susceptible to hydrolysis reactions to form ester substituted phenols and then finally the acid-substituted phenol, namely carboxylic acid substituted phenolic compounds. In one embodiment of the invention, an acidic stabilizer is added to the ester substituted diaryl carbonate in order to stabilize it. Preferably the acidic stabilizer will have sufficiently low thermal stability and low volatility so that it remains in the ester substituted diaryl carbonate during its purification, transportation and storage prior to use. It may be preferred to use an acidic stabilizer of intermediate stability and volatility so that it remains in the ester substituted diaryl carbonate during purification, transport and storage but so that it is readily removed at the initiation of the oligomerization and/or polymerization process. In one embodiment, an inorganic or organic acid or its hydrolysable ester is added as a stabilizer. Inorganic acids and their hydrolysable esters may be preferred as stabilizers due to their greater thermal stability and lower volatility versus many organic acids and their esters. Suitable acidic stabilizers include and are not limited to phosphorus-based acids and their esters.

### Method of Preparing an Ester Substituted Diaryl Carbonate Mixture:

It has been found that after the formation reaction to produce the ester substituted diaryl carbonate, that the pH of the resulting ester substituted diaryl carbonate mixture should be adjusted, if necessary, to a pH level below 11, more preferably lower than 10 and most preferably lower then 8 to prevent the degradation of the ester substituted diaryl carbonate back to the ester substituted phenol and to prevent the ester substituted phenol from reacting to form carboxylic acid substituted phenol. Furthermore, it has been found that the ester substituted diaryl carbonate should be prevented from coming into contact with water, transesterification catalyst, and heat also to prevent the formation of carboxylic acid substituted phenols. The step of adjusting the pH of the ester substituted diaryl carbonate mixture to a pH of less than 11 is necessary where the mixture is in aqueous form and where the mixture has a pH above 11 it is treated to lower the pH of the mixture to a point below 11. Therefore, in one embodiment the present invention provides a method of preparing an ester substituted diaryl carbonate mixture suitable for use in a melt polymerization reaction. The method comprises the steps of:
(a) providing an initial ester substituted diaryl carbonate mixture comprising an ester substituted diaryl carbonate, wherein said initial ester substituted diaryl carbonate mixture contains acid-substituted phenol, if at all, in an amount less than 100 ppm,
(b) measuring the pH, and adjusting, if necessary, the pH of the initial ester substituted diaryl carbonate mixture to a pH of less than 11, and
(c) controlling contact of the ester substituted diaryl carbonate mixture with water, transesterification catalyst, and/or heat,
   whereby the amount of acid-substituted phenol present in the ester substituted diaryl carbonate mixture is maintained in an amount less than 100 ppm, thereby preparing an ester substituted diaryl carbonate mixture suitable for use in a melt polymerization reaction.

In preferred embodiments the amount of acid-substituted phenol present in the initial ester substituted diaryl carbonate mixture is less than 70 ppm, preferably less than 50 ppm, more preferably less than 10 ppm, and most preferably less than 5 ppm and the amount of acid-substituted phenol present in the resulting mixture. It is further preferred that the amount of acid-substituted phenol present in the resulting ester substituted diaryl carbonate mixture is maintained at the level present in the initial ester substituted diaryl carbonate mixture. However, in some embodiments the amount of acid-substituted phenol present in the resulting ester substituted diaryl carbonate mixture may be higher than that in the initial mixture but still less than 100 ppm. Depending on the initial level of acid-substituted phenol, it is preferred that the resulting ester substituted diaryl carbonate mixture have less than 70 ppm, for example in an amount of less than 50 ppm, such as less than 10 ppm, or less than 5 ppm acid-substituted phenol present.

In another embodiment the resulting ester substituted diaryl carbonate mixture produced by the above method may be subsequently treated to reduce the level of acid-substituted phenol to the levels described above. Depending on the level of acid-substituted phenol present in the resulting mixture, the mixture may be treated to further reduce the acid-substituted phenol level to the more preferred levels described above.

The step of adjusting the pH of the initial ester substituted diaryl carbonate mixture to a pH of less than 11 is not particularly limited. This step is “necessary” when the ester substituted phenol is in an aqueous form and when the pH of the aqueous form is above 11. However, the inventors have found that it is desirable to further reduce the pH to less than 10 and most preferably less than 8. The pH can readily be monitored with an electrode and a sufficient amount of an organic and/or inorganic acid or their hydrolysable esters may be added in one step, stepwise or continuously in the form of a solid, liquid, or solution until a pH of less than 11, 10, and even less than 8 is reached. Because high levels of acidic impurities may interfere with the subsequent oligomerization and/or polymerization of the ester substituted diaryl carbonate, it may be preferable to not reduce the pH more than is needed to prevent the hydrolysis of the ester substituted diaryl carbonate. In one embodiment, the pH is reduced to a value between 5 and 11. In other embodiments, the pH is reduced to ranges of between 6 and 10.9, specifically between 6.5 and 10, and more specifically between 7 and 8. Because the ester substituted phenolic compound is an intermediate in the formation of the carboxylic acid substituted phenolic compound, in one embodiment the risk of formation of the acid-substituted phenol may be monitored by monitoring the concentration and any formation of the ester substituted phenolic compound. If the content of the phenolic compound is observed to increase, a sufficient amount of an acidic stabilizer may be added to quench further reaction to form the ester substituted phenolic compound and the subsequent carboxylic acid substituted phenolic compound. In one embodiment the pH can be adjusted by the addition of an acid, for example a phosphorus containing acid such as H₃PO₄. Other phosphorus containing acids and additional benefits of adding the phosphorus containing acid on the resulting polycarbonate can be found below in the example section and in U.S. patent application Ser. No. 11/668,551 which is incorporated herein by reference.

The step of controlling contact of the ester substituted diaryl carbonate mixture with water, transesterification catalyst, and/or heat is likewise not particularly limited. In one embodiment, contact with heat is controlled and the mixture is maintained in a solidified form at a temperature below its melting point. If the mixture is maintained in the molten form, it is maintained at a temperature of less than 50° C., specifically 40° C., more specifically 30° C., yet more specifically 20° C. and most specifically 10° C. above the solidification point of the molten mixture. It may be preferable to maintain the temperature somewhat higher than the solidification temperature so that the viscosity of the molten mixture is sufficiently low for easy transfer by flow, and pumping etc. In another embodiment contact with water is controlled and the mixture is stored under a low humidity or water-free atmosphere such as a dry nitrogen atmosphere or purge. In other embodiments, any residual water or transesterification catalyst is thoroughly removed from the storage containers, transfer vessels, valves, piping and lines etc. prior to the admittance of the mixture. In specific embodiments, water is be removed by the application of heat and/or atmospheric flow and/or volatile inert solvent and/or a wash of the ester substituted diaryl carbonate and or an ester substituted phenolic compound. Any storage containers, transfer vessels, valves, reactors, piping and lines etc. that have previously contained the acid-substituted phenol or an acidic or basic substance or one that may act as a transesterification catalyst or one that readily hydrolyzes to give a transesterification catalyst or acidic compound or basic compound, should be sufficiently cleaned prior to admitting the ester substituted diaryl carbonate or reaction mixture so that it does not hydrolyze to give the acid-substituted phenol (i.e. a carboxylic acid substituted phenolic compound). If a caustic solution is used for cleaning storage containers, transfer vessels, valves, piping and/or lines etc., the cleaned surfaces should thoroughly be rinsed with inert solvent and/or water until the rinse solution is essentially pH neutral.

In one embodiment the risk of formation of the acid-substituted phenol may be monitored by monitoring the concentration and any formation of the ester substituted phenolic compound. If the content of the phenolic compound is observed to increase, a sufficient amount of an acidic stabilizer may be added to quench further reaction to form the ester substituted phenolic compound and the subsequent carboxylic acid substituted phenolic compound. In one embodiment the pH of an aqueous solution or extract of the mixture is measured. In one embodiment the concentration of the extract or solution is between 1 and 99 mass % of the mixture in water, specifically between 2 and 50 mass %, more specifically between 5 and 20%. If the pH of the aqueous solution or extract is above 11, a sufficient amount of acidic stabilizer is added to the mixture in one embodiment to reduce the pH of the extract to less than 11, more preferably less than 10 and most preferably less than 8 as described above.

### Methods of Forming Polycarbonate:

The present invention also provides methods of producing polycarbonate. In one embodiment the present invention provides a method of forming polycarbonate wherein the method comprises the steps of:
(a) providing a first ester substituted diaryl carbonate mixture comprising an ester substituted diaryl carbonate, wherein said first ester substituted diaryl carbonate mixture may contain acid-substituted phenol,
(b) treating the first ester substituted diaryl carbonate mixture to reduce the level of acid-substituted phenol, if present, to an amount of less than 100 ppm, thereby creating a second ester substituted diaryl carbonate mixture,
(c) forming a melt reaction mixture comprising the second ester substituted diaryl carbonate mixture, a dihydroxy compound, and a melt transesterification catalyst,
(d) allowing the melt reaction mixture to react to build molecular weight, thereby preparing polycarbonate.

In another embodiment the present invention provides a method of producing polycarbonate comprising the steps of:
(a) forming a melt reaction mixture comprising an ester substituted diaryl carbonate mixture, a dihydroxy compound, and a melt transesterification catalyst, wherein:
   the ester substituted diaryl carbonate mixture may contain acid-substituted phenol and is:
   (i) tested for the presence of said acid-substituted phenol prior to forming the melt reaction mixture, and
   (ii) if said acid-substituted phenol is present, treated to reduce the level of said acid-substituted phenol to an amount of less than 100 ppm prior to forming the melt reaction mixture,
(b) allowing the melt reaction mixture to react to build molecular weight, thereby preparing a polycarbonate.

In another embodiment the present invention provides a method of producing polycarbonate comprising the steps of:
(a) providing a melt reaction mixture comprising a dihydroxy compound, an ester substituted diaryl carbonate mixture, and a melt transesterification catalyst, wherein the ester substituted diaryl carbonate mixture may contain acid-substituted phenol,
(b) determining the amount of acid-substituted phenol present in the melt reaction mixture and adjusting the molar ratio of acid-substituted phenol to melt transesterification catalyst (acid-substituted phenol/catalyst) in the melt reaction mixture to an amount of less than 10, and
(c) allowing the melt reaction mixture to react to build molecular weight, thereby preparing polycarbonate.

As described above, in preferred embodiments the amount of acid-substituted phenol present in the melt reaction mixture is maintained in an amount less than 100 ppm, for example less than 70 ppm, such as in an amount of less than 50 ppm, for example less than 10 ppm, or less than 5 ppm. In other embodiments the acid-substituted phenol is present in a molar ratio to the amount of melt transesterification catalyst in a molar ratio of less than 10/1 and more preferably in a molar ratio of less than 5/1 for example less than 2/1 like less than 1.1/1.

In one embodiment the step of treating the ester substituted diaryl carbonate to reduce the level of acid-substituted phenol is performed irrespective of whether the acid-substituted phenol is present. In another embodiment the level of acid-substituted phenol in the ester substituted diaryl carbonate is determined and depending on its presences and concentration a subsequent step of reducing its level is performed.

As described above with regard to the method of producing the ester substituted diaryl carbonate mixture, the formation reaction of the acid-substituted phenol may be controlled by controlling the contact of the ester substituted diaryl carbonate mixture with certain materials or conditions. Therefore, in another embodiment the methods of producing polycarbonate further comprise the step of controlling contact of the ester substituted diaryl carbonate mixture with water, transesterification catalyst, and heat, such that the amount of acid-substituted phenol present in the second ester substituted diaryl carbonate mixture is maintained at less than 100 ppm until formation of the melt reaction mixture.

### Methods of Adjusting the Molar Ratio of Acid-Substituted Phenol to Catalyst and Reducing Acid-Substituted Phenol Concentration:

The step of treating the ester substituted diaryl carbonate or the melt reaction mixture is not particularly limited. For example, in one embodiment, the level of acid-substituted phenol present is reduced by the addition of an ester substituted diaryl carbonate mixture containing a lower level of acid-substituted phenol.

In another embodiment, the level of acid-substituted phenol is reduced by carrying out an ion exchange or absorption process. Such ion exchange or absorption processes may be carried out by passing a melt or solution of the ester substituted diaryl carbonate or the melt reaction mixture through or placing it in contact with an ion exchange material or absorbent. In one embodiment, the treatment with the ion exchange material or absorbent is in a batch treatment of a solution or a melt in which the solution or melt is treated with the ion exchange material or absorbent in a batch tank, the exchange or absorption is allowed to come to equilibrium, then the ion exchange material or absorbent is separated from the solution or melt. In another embodiment, the ion exchange or absorption process is done in a batch, continuous or semi-continuous process using a column containing a fixed bed of ion exchange material or absorbent.

In one embodiment, the ion exchange or absorbent material is an inorganic material such as zeolite, montmorillonite, silica gel, or clay. In another embodiment, the ion exchange or absorbent material is an organic material such as a synthetic or natural ion exchange resin or humus. In one specific embodiment, a strong basic anion ion exchange material is used to reduce the level of acid-substituted phenol.

Since acid-substituted phenol is typically more volatile and less thermally stable than ester substituted diaryl carbonate or melt reaction mixtures, the acid-substituted phenol level in these compositions may be reduced in one embodiment by the application of heat to a melt of the composition, particularly with the application of vacuum or a flow of inert gas to facilitate the removal of the acid-substituted phenol and/or its thermal decomposition products. In one embodiment, this thermal treatment to reduce the acid-substituted phenol level takes place during the process of forming the melt reaction mixture or during the oligomerization stage of the melt reaction mixture.

In a further embodiment where the molar ratio of acid-substituted phenol to melt transesterification catalyst is more than 1, 2, 5 or 10, it is possible to increase the level of melt transesterification catalyst so that the molar ratio is less than 10, preferably less than 5, more preferably less than 2, and most preferably less than 1.1. However this method is not generally preferred because increasing the amount of the melt transesterification catalyst may have a detrimental impact on the resulting polycarbonate properties, such as color, polydispersity, and byproduct levels.

Because the ester substituted diaryl carbonate is a less complex and also typically lower viscosity and molecular weight composition than the melt reaction mixture, additional conventional purification methods may be applied to reduce the level of acid-substituted phenol present in it. For example, in one embodiment, the level of acid-substituted phenol present in the ester substituted diaryl carbonate is reduced by a solvent recrystallization process. In another embodiment, the level is reduced by a vacuum distillation process.

### Measurement of the Acid-Substituted Phenol Content in Ester Substituted Diaryl Carbonate Mixtures and Melt Reaction Mixtures

The acid-substituted phenol content of ester substituted diaryl carbonates and melt reaction mixtures may be readily measured by a variety of conventional quantitative methods for the quantitative characterization of low molecular weight organic molecules known in the art. Such quantitative analytical methods include chromatographic and spectroscopic methods. In order to minimize the complexity of the measurement, it may be advantageous to remove high molecular weight species and other potentially interfering species prior to analysis of the acid-substituted phenol content by methods in the art. For example, the acid-substituted phenol will typically be soluble in water and other polar solvents, whereas the ester substituted diaryl carbonates and their oligomers are not. Therefore the acid-substituted phenol may typically be separated from many other species by extracting the acid-substituted phenol to an aqueous or polar solvent phase from a non-miscible solution containing the ester substituted diaryl carbonates or melt reaction mixture to be analyzed (solvent extraction). Alternatively the acid-substituted phenol may be extracted directly to water or other polar solvent directly from a powder, gel, or dispersion of the ester substituted diaryl carbonates or melt reaction mixture to be analyzed.

In the analysis of ester substituted diaryl carbonates, it is preferred to extract the acid-substituted phenol directly to water from a powdered sample of the ester substituted diaryl carbonates. In the analysis of melt reaction mixtures, it is preferred to perform a solvent extraction to extract the acid-substituted phenol to an aqueous phase from a solution of the melt reaction mixture in dichloromethane. Because the ester substituted diaryl carbonate may hydrolyze with time upon contact with water and base, particularly at elevated temperatures, the sample extraction should be carried out fairly rapidly, and the extracted sample should subsequently be analyzed fairly rapidly. A suitable extraction time will typically be 30 minutes, and the extracted sample may typically be analyzed within 1 or 2 hours of its preparation. Any potential hydrolysis effects may be evaluated and their effects minimized by carrying out a study of the effects of extraction time and time between sample extraction and analysis on the acid-substituted phenol measurement to determine the optimum times to be used in the measurement method. Alternatively hydrolysis may be suppressed by addition of a suitable quencher species, such as typically a weak organic acid, or by simply controlling the pH of the aqueous extraction phase.

The acid-substituted phenol concentrations and levels referred to in the specification are those as measured by the HPLC method. For example, in the illustrations of the invention the content of the acid-substituted phenol (e.g. salicylic acid (SA)) in the ester substituted diaryl carbonate (e.g. BMSC) and its reaction mixtures was measured on a HPLC HP1100 using an Inertsil ODS-3, 5 μm, 4.6 mm×15 cm column. An analytical sample was prepared from BMSC by melting approximately 5 g of BMSC and then pulverizing it into a fine powder. Approximately 2.5 g±0.005 g of the sample is weighed out into a 30 ml vial. The sample was then extracted in 10 ml of water (milli-Q quality) in an ultrasound bath over a period of 30 minutes. After filtration, 25 ul of the sample was injected and the SA content was analyzed at 306 nm wavelength using a solvent mixture of 35% acetonitrile and 65% water (with 1% trifluroacetic acid). The salicylic acid peak was detected at 6.4 min of retention time. Before measurement the equipment was calibrated in a range of 0 to 1000 ppm of SA using prepared solutions of SA in water. The detection limit of this method is approximately 1 ppm SA.

### EXAMPLES

Having described the invention in detail, the following examples are provided. The examples should not be considered as limiting the scope of the invention, but merely as illustrative and representative thereof.

### Example 1

### Reactivity Testing (RT)

### (1) General RT Procedure:

Ester-substituted phenols such as methyl salicylate (MS) or other alkyl, aryl, or alkaryl salicylates are produced as a condensation byproduct during the melt manufacture of polycarbonate using an ester substituted diaryl carbonate together with diol monomers and optionally other monomers such as di-esters, di-acids, or monofunctional phenolic chain stoppers.

A reactivity test (RT) is similar to this process but it is not a polymerization. A RT is actually a melt transesterification between an alcohol, for instance para-cumyl phenol (PCP) and an ester substituted diaryl carbonate. Samples are taken at specific times. The concentration of the ester substituted phenolic byproduct from this reaction is then measured and plotted over time. In this example bismethylsalicylcarbonate (BMSC) was used.

The set-up used for the RT is a 3-neck round-bottom flask. It is immersed in an oil bath to control the temperature, and it is equipped with a thermometer for measuring the temperature of the mixture in the flask and a magnetic stirrer for stirring the contents of the flask. It is further equipped with a nitrogen purge for maintaining an inert atmosphere during the test, and one of the openings can be used to remove samples as a function of time by means of a pipette and while maintaining the inert atmosphere within the flask.

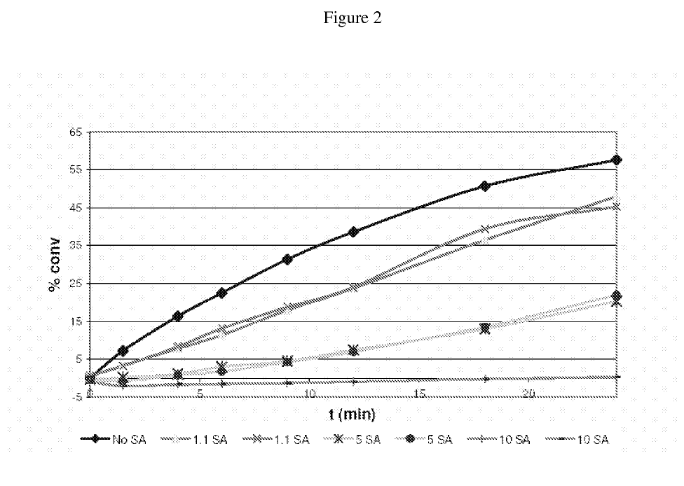

In the present example a series of spiking tests using salicylic acid (SA) as the carboxylic acid substituted phenol were carried out according to the above RT description in order to illustrate the effects of such acidic impurities on the oligomerization stage of a polymerization process using ester substituted diaryl carbonates as monomer. The amounts of SA added to the RT are chosen in the same order of magnitude as the melt transesterification catalyst, TMAH. The reason for this is that the basic catalyst could already be quenched by an equivalent amount of SA. As the amount of SA to be added is less than a milligram, weighing the proper amount is not possible. Therefore SA is dissolved in acetone (the SA solubility in acetone is around 0.3 g/ml, which is more than sufficient) in such a concentration that the addition of 5 ml of the solution contains the desired quantity of SA. The results are depicted below in Table 1 and in FIG. 2.

TABLE 1
Results

| SA/TMAH | | |
|---|---|---|
| ratio | Slope | K |
| 0 | 4.05 | 166.51 |
| 0 | 1.42 | 55.1 |
| 1.1 | 1.84 | 85.55 |
| 1.1 | 1.96 | 87.15 |
| 5 | 0.37 | 20.8 |
| 5 | 0.34 | 21.52 |
| 10 | BDL | BDL |
| 10 | BDL | BDL |

### (2) Discussion:

The results of example 1 show that an excess of acid quenches the reaction. Because SA is a weak acid (pKa=2.97) and TMAH is a strong base, at the equivalent point the solution is basic. The observed trend in reactivity as a function of SA/cat molar ratio allows us to conclude that the presence of SA will reduce the reactivity during the oligomerization step. At a molar ratio (SA/TMAH) equal to 10, a complete loss of reactivity was found. This amount of salicylic acid corresponds to a concentration of about 125 ppm SA in BMSC in this particular reactivity test. In addition such SA/catalyst ratios of around 10 also corresponds to concentrations of SA in BMSC of about 125 ppm based on typical concentrations of basic catalyst used in melt polymerizations.

It is also noted that when using a 1.1 SA/TMAH ratio a decrease in reactivity is seen. This ratio corresponds to a concentration of about 10 ppm of SA in BMSC in this test and typical melt polymerizations. Therefore it is preferred to have a maximum molar ratio of carboxylic acid substituted phenolic compound/catalyst of less than 5, preferably less than 2 and more preferably less than 1.1.

### Example 2

### Melt Polymerization Testing and Spiking of SA

### (1) General Procedure:

Standard small scale melt polymerization batch experiments using BMSC were carried out according to the conditions described in Table 2.

The following materials were used in this example. 25 mass % TMAH solution: Sachem Inc, Part Code 322, Lot #C02124X65800. 0.5 mol/l NaOH, Acros, J/7630C/05. Bismethylsalicylcarbonate (BMSC) and Bisphenol A were supplied by GE Plastics.

The batch polymerizations were carried out in a small scale reactor system. This system has 2 identical glass tube reactors which have the same vacuum system. This melt polymerization unit is equipped with a high vacuum system to remove all methyl salicylate formed as a byproduct in the polymerization reaction. The methyl salicylate is contained in the condensers.

In this system the glass reactors are charged at ambient temperature and pressure with the solid diol monomer, BPA, and the solid ester substituted diaryl carbonate BMSC using a ratio of ˜1.020 (BMSC:BPA). After this charging step, any SA to be introduced into the sample was spiked by injecting the appropriate volume of a solution of SA in acetone (solution concentration of 0.2 mass %) into the monomers, and then the reactor was sealed shut. It should be noted that analysis of the BMSC indicated no detectable SA, therefore it can be concluded that all of the SA in these examples comes exclusively from the spiked SA. The system was deoxygenated by briefly evacuating the reactors and then introducing nitrogen. This process was repeated three times. The catalysts tetramethyl ammonium hydroxide and sodium hydroxide were next added as an aqueous solution, using respectively 25×10⁻⁵ mol TMAH/mol BPA and 1×10⁻⁶ mol NaOH/mol BPA. The reaction was carried out according to the specific profile shown in Table 2. The content and concentration of the polymerization reactants are summarized in Table 3, and the molecular weight of the polymer products are reported relative to polystyrene standards there as well. The molar ratio, SA/catalyst, refers to the molar ratio of SA to the molar sum of NaOH and TMAH.

The molecular weight measurements of the materials prepared in the examples have been carried out by means of Gel Permeation Chromatography (GPC). A 12-point calibration line covering the entire molecular weight range of was constructed using polystyrene standards with a narrow molecular weight distribution (polydispersity (PD) of less than 1.01). All polycarbonate samples were measured against the calibration curve and molecular weights were expressed relative to the measured polystyrene molecular weights. Polycarbonate BPA homopolymers were dissolved in chloroform solvent prior to measurement, and the mobile phase was a mixed solvent (5/95 vol/vol) of HFIP in chloroform. All molecular weight measurements were conducted within two hours of solution preparation.

TABLE 2
Reactor conditions

| | time | Pressure | T° reactor | T° Overheads |
|---|---|---|---|---|
| Step | (min.) | (mbar) | (° C.) | (° C.) |
| Melting | 10 | ATM | 180 | 100 |
| 1 | 30 | 500 | 180 | 100 |
| 2 | 5 | 500 | 270 | 100 |
| 3 | 10 | <1 | 300 | 100 |

TABLE 3
Results

| | | | | | | | | Polymer |
|---|---|---|---|---|---|---|---|---|
| | Polymerization Reactants | | | | | | | Product |
| Sample | mass BPA | mass | Molar Ratio | NaOH | TMAH | SA spiked | molar ratio | Mw |
| Example | (g) | BMSC (g) | BMSC/BPA) | (ppb) | (ppm) | (ppm) | SA/catalyst | (g/mol) |
| 1 | 24.8 | 36.6 | 1.02 | 100 | 6.76 | 0 | 0 | 58,240 |
| 2 | 24.8 | 36.6 | 1.02 | 100 | 6.76 | 0 | 0 | 54,970 |
| 3 | 24.8 | 36.7 | 1.02 | 100 | 6.76 | 601 | 57 | 26,882 |
| 4 | 24.8 | 36.6 | 1.02 | 100 | 6.76 | 5866 | 550 | 12,236 |

### (2) Discussion:

The results given in Table 3 indicate that the presence of the carboxylic acid substituted phenolic compound, SA, has a severely detrimental effect on the polymer conversion. Without wishing to be bound to a particular mechanism, the inventors believe that the SA is effective in inhibiting reaction in the early part of the polymerization, namely the oligomerization stage (step 1 in Table 2). It is believed that at higher temperatures and/or lower pressures later in the polymerization (such as in step 2 and 3 of Table 2), the SA may be thermally degraded and/or devolatized and/or incorporated into the polymer chain. After this point, the transesterification reaction can then proceed. It can be seen from example samples 3 and 4 though that the initial inhibition of reactivity cannot adequately be compensated for in the later stages of the polymerization process. Therefore progressively lower degrees of conversion and thus lower molecular weight are obtained as the level of SA spiked in the reaction increases.

### Example 3

### Additional Melt Polymerization Testing and Spiking of SA

### (1) General Procedure:

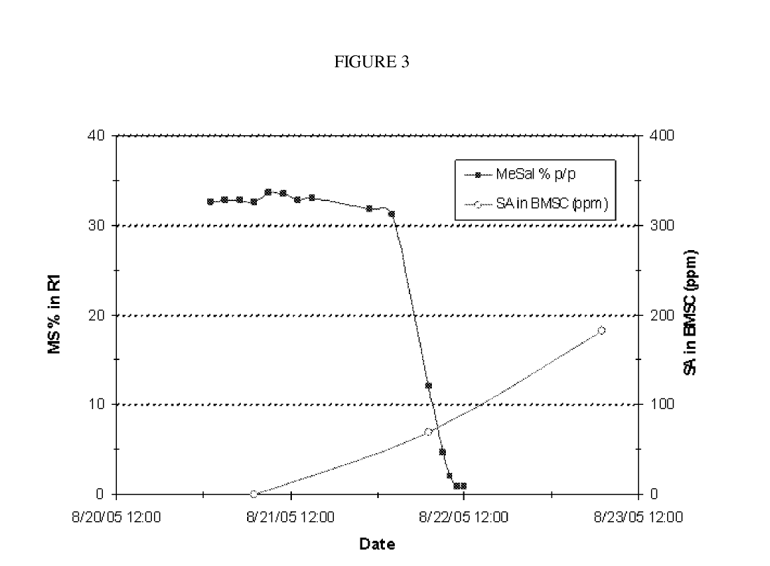

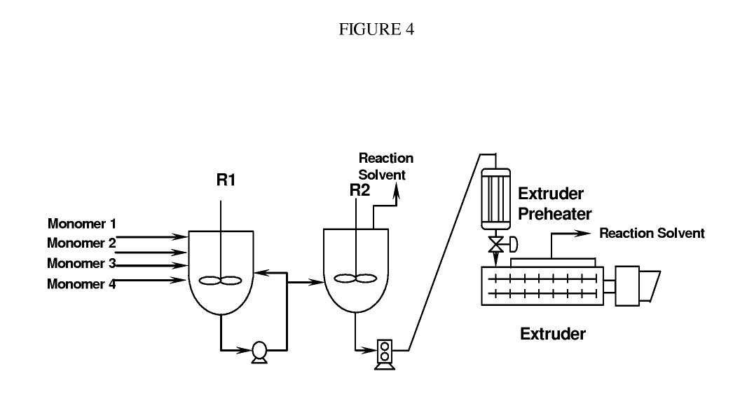

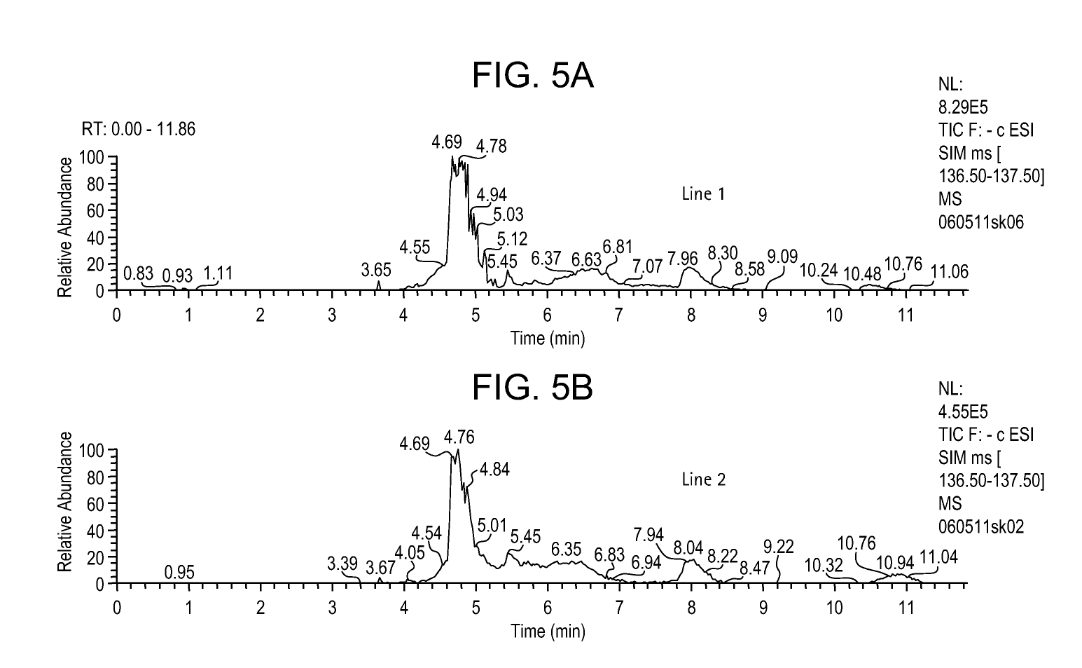

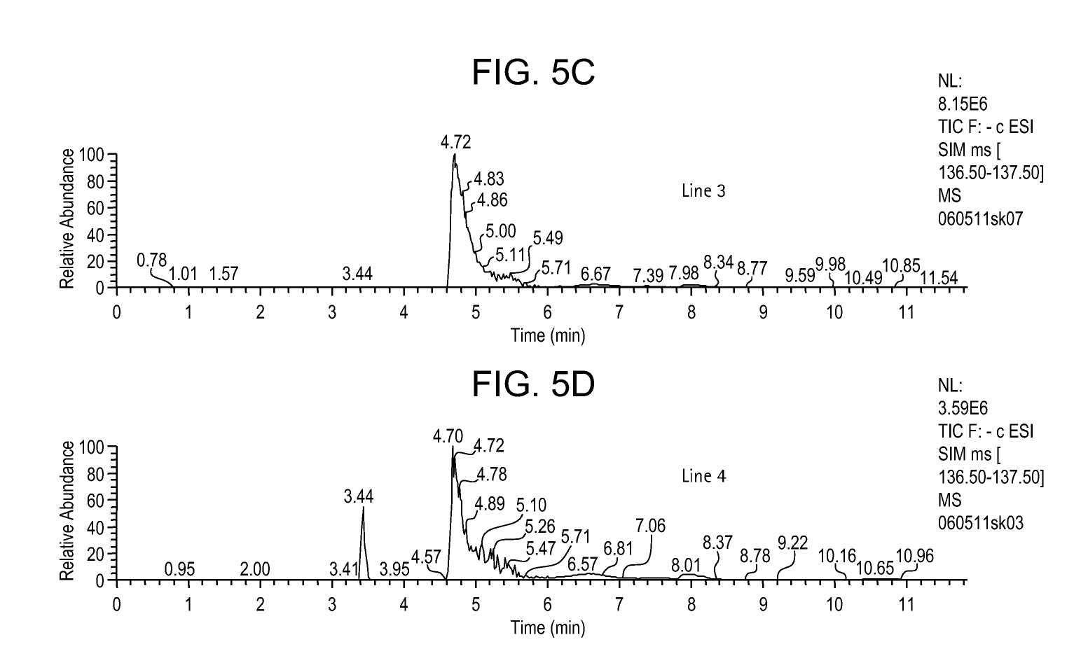

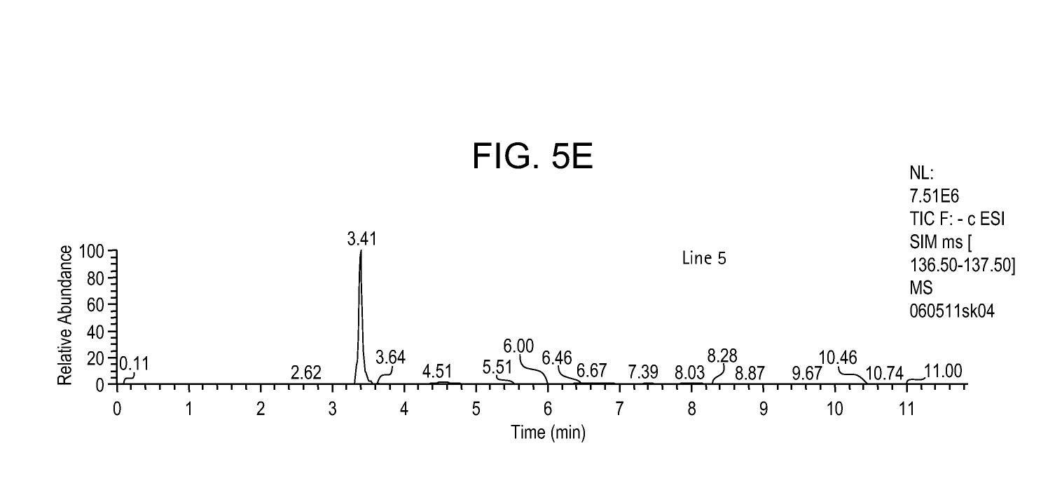

Pilot plant results for BMSC terpolymer formulation BPA/HQ/MeHQ 33/34/33 (mole %). The presence of SA affected negatively the conversion in R1 (Reactor 1 as shown in FIG. 4) (i.e. the oligomerization stage) as shown in the graph shown in FIG. 3. Under normal operating conditions of a plant run with 40 ueq of TMAH, the amount of MS formed in R1 stage is around 32%. As can be seen in FIG. 3 if the concentration of SA is above about 50 ppm it can reduce the conversion significantly until 0% conversion with increased concentrations of SA, e.g. above about 100 ppm, in BMSC.

### (2) Discussion:

The content of the phenolic byproduct methyl salicylate (MS) in R1 is a measure of the extent of conversion in that reactor. Typically the amount of MS in R1 is about 32 mass %. As can be seen in FIG. 3, the presence of the carboxylic acid substituted phenolic compound SA severely negatively affects the conversion in the early stages of the polymerization process in the first CSTR. As the SA content of the BMSC reached a level of about 70 ppm (molar ratio of salicylic acid/catalyst of approximately 5.6), the mass % of MS drops precipitously down to approximately 0% MS and thus zero conversion by the time that the salicylic acid content increases up to a value of about 100 ppm in the BMSC. At about 100 ppm SA in BMSC, the molar ratio of salicylic acid/catalyst has reached a value of approximately 8.

This loss in reactivity in R1 has quite serious consequences in a continuous process because the fixed residence times in later stages of the process limit the possibility to recover the lost conversion in later stages. Such lost conversion reduces the extent of conversion and thus molecular weight of the final product polymer. In addition the fixed nature of the vacuum overhead limits the capability to remove any additional MS formed at later stages of the polymerization process. Therefore the polymer products from production runs having inhibition of conversion in the early stages of the reaction also typically contain increased levels of residual MS, which then has a negative impact on such polymer properties as color and stability.

### Example 4

### Salicylic Acid Formation in BMSC

### Equipment:

30 ml vial with screw cap, plastic syringe 20 ml, green 20 micrometer filters for syringes, HPLC vials 1 ml, HPLC Agilent 1100 Series with UV detector, LABO TECH shaker RS 500, pH meter CG 822, pH Electrode, Balance Methler Toledo, magnetic stirrer, 50 ml volumetric flask

### Chemicals:

0.01% HCL solution, 0.5M NaOH solution, Dichloromethane (DCM) HPLC quality, BMSC, salicylic acid (SA) 99.8%, Buffer solutions pH 4, 7 and 11 from L.P.S Benelux B.V.

### Procedure:

### (1) Preparation of BMSC Solutions:

In six 30 ml vials with screw cap 16 ml of a 20% BMSC solution in dichloromethane (DCM) were added.

### (2) Preparation of Aqueous Solutions Having Specific pHs:

In six 30 ml vials having screw caps, 20 ml deionized water was added. With 0.01% HCL solution and 0.5M NaOH solution, the pH was then adjusted to values of pH 6, 8, 10, 12 or 13 respectively. The 6th sample is a blank in which the pH has not been adjusted (pH tap water 8.45). (PH meter first adjusted with Buffer solutions 4, 7 and 11.)

(3) Hydrolysis Reaction of BMSC to form SA at various pH's:

An aliquot of 8.6 ml from the respective pH water solution was added to the BMSC solution yielding 2 phases. The vials containing the 2 phases were placed on a shaker and left to react at room temperature. (180 oscillations per minute). The ratio of the DCM phase to the water phase was 2:1 (vol:vol). (Samples were taken after 1 h, 3 h and 24 h)

TABLE 5
Preparation of 2-Phase Systems

| | | | | | Mass % |
|---|---|---|---|---|---|
| | | Base/acid | | | BMSC |
| | Amount | used to | Amount | Amount | based on |
| Water phase | water phase | adjust pH | BMSC | DCM | DCM |
| PH2 | 8.3 ml | HCL | 4.484 | 16.6 ml | 20.46 |
| pH 6 | 8.3 ml | HCL | 4.435 | 16.6 ml | 20.24 |
| pH 8 | 8.3 ml | HCL | 4.440 | 16.6 ml | 19.92 |
| pH 10 | 8.3 ml | NaOH | 4.427 | 16.6 ml | 19.91 |
| PH 11 | 8.3 ml | NaOH | 4.468 | 16.6 ml | 20.39 |
| pH 12 | 8.3 ml | NaOH | 4.471 | 16.6 ml | 20.20 |
| pH 13 | 8.3 ml | NaOH | 4.443 | 16.6 ml | 20.15 |

### (4) Preparation of a Standard Solution of 200 ppm Salicylic Acid:

A standard 200 ppm salicylic acid solution was prepared (in 50 ml volumetric flask) and then filtered through a 20 μm filter into a 1 ml HPLC vial. The standard solution was then injected to check the retention time of salicylic acid on the HPLC column.

### (5) Sample Preparation for HPLC Analysis of SA Content:

A 2 ml aliquot was taken from either the upper water phase or the lower organic phase of the 2-phase system using a 20 ml plastic syringe. This solution was filtered through a Mm filter into a 1 ml HPLC vial.

### (6) HPLC Measurement of SA Content:

Used HPLC (Agilent 110 Series with UV detector)
(7) Method S_RES_SA:
Description: RP-LC-UV
Column: ODS-3 5 um 4.6×150 mm
Flow: 1.200 ml/min
Stop time: 28 min
Inject volume: 10 1
Max pressure: 20 bar
Min pressure: 5 bar

### Solvent:

A: water+0.1% TFA
B: MeCN
C: H2O
D: THF

TABLE 6
HPLC Analysis Procedure

| | Time | % B | % C | % D | Flow |
|---|---|---|---|---|---|
| 1 | 0.83 | 5.0 | 0.0 | 0.0 | 1.200 |
| 2 | 15.00 | 95.0 | 0.0 | 0.0 | 1.200 |
| 3 | 15.83 | 95.0 | 0.0 | 0.0 | 1.200 |
| 4 | 17.50 | 0.0 | 0.0 | 95.0 | 1.200 |
| 5 | 21.67 | 0.0 | 0.0 | 95.0 | 1.200 |
| 6 | 23.33 | 5.0 | 0.0 | 0.0 | 1.200 |

### (8) Results:

Samples were taken after 1, 3, and 24 hours and analyzed for the MS and SA content of the aqueous and organic phases. The levels of MS and SA in these samples are reported in Table 7 for the aqueous phases and in Table 8 for the organic phases. Salicylic acid (SA) has been detected in the water-phase samples having high pH values, namely pH 11, 12 and 13. In the other aqueous samples and all of the organic phase samples, no salicylic acid could be detected after 24 hours of exposure to water.

MS was found as an intermediate hydrolysis product of BMSC in both the organic phase and aqueous phase of some of the samples. The concentration of MS was generally higher in the organic phase than in the aqueous phase samples. As in the case of SA, the higher concentrations of MS were generally found in the samples exposed to aqueous solutions having high pH's, especially after longer periods of time.

TABLE 7
MS and SA content of aqueous phase of 2-phase
system as a function of time and pH

| pH | Time (hours) | MS (ppm) | SA (ppm) |
|---|---|---|---|
| 2 | 1 | BDL | BDL |
| | 3 | BDL | BDL |
| | 24 | BDL | BDL |
| 6 | 1 | BDL | BDL |
| | 3 | BDL | BDL |
| | 24 | 24.5 | BDL |
| 8 | 1 | BDL | BDL |
| | 3 | 4.2 | BDL |
| | 24 | BDL | BDL |
| 10 | 1 | BDL | BDL |
| | 3 | BDL | BDL |
| | 24 | BDL | BDL |
| 11 | 1 | BDL | 1.6 |
| | 3 | BDL | 1.3 |
| | 24 | BDL | 1.0 |
| 12 | 1 | 6.8 | 17.4 |
| | 3 | 1.6 | 19.4 |
| | 24 | 7.9 | 27.1 |
| 13 | 1 | 15.8 | 108 |
| | 3 | 1.1 | 145 |
| | 24 | 1452 | 50.4 |

BDL = Below detection limit (approximately 1 ppm)

TABLE 8
MS and SA content of organic (DCM) phase of
2-phase system as a function of time and pH

| | Time | | |
|---|---|---|---|
| pH | (hours) | MS (ppm) | SA (ppm) |
| 2 | 1 | 19.6 | BDL |
| | 3 | 33.9 | BDL |
| | 24 | 25.0 | BDL |
| 6 | 1 | 21.6 | BDL |
| | 3 | 33.9 | BDL |
| | 24 | 28.0 | BDL |
| 8 | 1 | 23.1 | BDL |
| | 3 | 35.7 | BDL |
| | 24 | 30.0 | BDL |
| 10 | 1 | 21.7 | BDL |
| | 3 | 36.6 | BDL |
| | 24 | 31.1 | BDL |
| 11 | 1 | 23.1 | BDL |
| | 3 | 35.3 | BDL |
| | 24 | 31.6 | BDL |
| 12 | 1 | 28.0 | BDL |
| | 3 | 49.4 | BDL |
| | 24 | 74.8 | BDL |
| 13 | 1 | 116 | BDL |
| | 3 | 253 | BDL |
| | 24 | 1331 | BDL |

BDL = Below detection limit (approximately 1 ppm)

### (9) Discussion and Conclusion:

BMSC is apparently sensitive only to base-catalyzed hydrolysis reactions but not to acid-catalyzed hydrolysis reactions. Therefore the undesired degradation of BMSC to MS and especially SA at room temperature in 2-phase (organic/aqueous) systems can be prevented by control of the pH of the aqueous phase. Maintaining pH values of the aqueous phase below 11, preferably below 10, and more preferably below 8 resulted in little or no formation of SA, even over substantial periods of time. It is also beneficial to minimize the time of exposure of BMSC to aqueous solutions having elevated pH's, for example, it is preferable to limit BMSC exposure to pH's of greater than 10 to exposure times of less than 60 minutes, preferably less than 30 minutes, more preferably less than 10 minutes, and most preferably less than 5 minutes. If BMSC is exposed to organic and/or inorganic bases or basic conditions, it is preferable to have any such exposure occur in a water-free environment. It is also preferable to avoid contact of the BMSC with other protic solvents such as alcohols if base is present. SA was found only in the aqueous phase, and no SA was detectable in the organic phase. MS was also found distributed through both the organic and aqueous phases as a hydrolytic degradation product, and similarly more MS is found in samples exposed to high pH's, especially over longer periods of time.

### Example 5

### The Use of Acidic Stabilizers to Inhibit the Degradation of BMSC to Form SA Upon Exposure to Water, Base, and Elevated Temperatures

### Preamble:

It has been found that exposure of BMSC to water under basic conditions results in hydrolytic degradation to give the undesired species SA, especially at elevated temperatures. In this illustration, it is demonstrated that the presence of an acidic stabilizer may be used to prevent such undesired degradation reactions in BMSC.

### Experimental Procedure:

All of the glassware in these experiments was first treated overnight in an acidic bath to remove any trace metal contaminants from the surface and then rinsed ten times with deionized water followed by three acetone rinses. A 50 ml round-bottom flask equipped with a reflux condenser was used for these experiments. A mass of 12 g of BMSC was placed into the round bottom flask along with any additional additives used in the illustration such as water, base or acid. The concentrations of all additives are given on a mass bass (mass % or ppm) relative to the mass of the BMSC used in the illustration. As the water volume injected in these illustrations is not sufficient to establish a reflux, 10 mL of THF solvent were also added to the flask.

For each showing, the round-bottom flask was first flushed with N₂ for 10 min prior to applying heat, and then the N₂ atmosphere was maintained by using a slow purge after reaction was initiating by placing the flask in an oil bath at a temperature of 130° C. Reaction was continued at this temperature over a period of 6 h and while maintaining continuous stirring.

The SA formation was monitored in each showing by removing aliquots of the BMSC mixture from the flask as a function of time in each showing using a Pasteur pipette. These aliquots were then dissolved in a solution of CHCl₃ and MeOH (1:2, vol:vol) and analyzed on an Agilent 1100 series HPLC equipped with a degasser and quartenary pump using these measurement parameters:

TABLE 9
Parameters for HPLC Analysis of SA content

| HPLC | |
|---|---|
| Parameter | Type/Value |
| Column | ODS-3, 5 μm 4.6 * 150 mm |
| Temperature | 35° C. |
| Detection signal | 280 nm |
| wavelength | |
| Detection | >0.1 min(2 s) |
| peakwidth | |
| Eluent | MeCN/H2O (5/95: |
| | vol/vol), no eluent gradient |
| | used |
| Flow | 1.200 ml/min. |
| Pressure limits | 5 to 200 bar |
| Injection | 10.0 μL |
| volume | |
| Total Run Time | 28.00 min. |

### (1) Results:

The SA content of the BMSC samples exposed to water at high temperatures in the presence of various additives are given as a function of time below in Table 10. In Illustration Nr. 1, it can be seen that a low level of SA is formed upon exposure of BMSC to water and a relatively low level of base. Some of this formed SA is apparently further degraded or perhaps devolatized with further exposure to these conditions. In Illustration Nr. 2, it can be seen that a much higher level of SA is rapidly formed and more SA continues to be formed as a function of time when the base concentration is higher. Illustration 3 demonstrates that this undesirable degradation to form SA can be significantly reduced when the BMSC contains an acidic stabilizer such as H₃PO₄.

TABLE 10
SA content of BMSC exposed to various conditions at high temperature

| | | SA concentration (ppm) in the BMSC | | | | |
|---|---|---|---|---|---|---|
| | Additive contained in the BMSC | as a function of melt-mixing time | | | | |
| Illustration Nr. | exposed to high temperature | 30 min | 1 h 30 min | 3 h | 4 h 30 min | 6 h |
| 1 | 2 mass % water + 160 ppm NaOH | 80.4 | 55.7 | 49.2 | 28 | 19.4 |
| 2 | 2 mass % water + 2000 ppm NaOH | 2256.6 | 4397.7 | 5134.1 | 5079.2 | 5390.5 |
| 3 | 2 mass % water + 2000 ppm NaOH + H3PO4 | 27.5 | 23.1 | 27.2 | 28.2 | 33.8 |
| | (1.5 mole ratio: acid/base) | | | | | |

### (2) Discussion:

It can be seen from these illustrations that BMSC can rapidly degrade within minutes under conditions of high temperature, high basicity and in the presence of water to give very high levels of the undesired impurity SA. The rate and amount of degradation to form SA is a strong function of the base concentration/pH.

This undesired degradation to form SA can be significantly reduced when the BMSC contains acidic stabilizers. This stabilizing effect can be effective for several hours. Suitable acidic stabilizing species will be acidic compounds having reasonably strong acidity, high thermal stability, low volatility, and low color. Ideally the acid will not be too corrosive towards the materials used for containing and transporting the BMSC. In one embodiment, the acidic stabilizer will be an inorganic acid. In another embodiment, the acidic stabilizer will be a phosphorus or sulphur based acids. In still another embodiment, the stabilizer will be a hydrolysable phosphate, phosphite, phosphate ester, phosphite ester, or organosulfate. In one specific embodiment, the acidic stabilizer will be selected from the group consisting of phosphoric acid, polyphosphoric acids, phosphates, metaphosphoric acids, metaphosphates, phosphate esters, and phosphite esters. polyphosphate, phosphoric acid, phosphorus acid, pyrophosphoric acid (H₄P₂O₇), tripolyphosphoric acid (H₅P₃O₁₀), tetrapolyphosphoric acid (H₆P₄O₁₃), trimetaphosphoric acid, sulphuric acid, and sulphurous acid.

The concentration of the acidic stabilizer in the BMSC will be generally kept low so as to not interfere with the subsequent polymerization of the BMSC monomer. The concentration of the acidic stabilizer will be high enough though to counteract the effect of low level basic contaminants, for example resulting from contamination or residues from washing or cleaning processes or from impurities left behind from the transport and/or storage of other raw materials and chemicals. Ideally the content of the acidic stabilizer will be sufficient to neutralize any basic contaminant to which the BMSC is exposed. The optimum content of the acidic stabilizer will depend somewhat on its properties such as strength of acidity, volatility, thermal stability, and molecular weight. In specific embodiments, the content of the acidic stabilizer in the BMSC will be between 0.1 and 50,000 ppm, 1 and 10,000 ppm, and 2 and 1,000 ppm. It may be desirable to increase the content of the acidic stabilizer or add subsequent amounts of acidic stabilizer depending upon the length and temperature of the BMSC storage and the basicity of the contaminants to which it is exposed and the water/humidity level to which it is exposed.

In one embodiment, samples of the stored BMSC will be taken over the course of the storage, and the pH of a water extract of the samples will be measured. Enough acidic stabilizer will be added to the BMSC so as to keep the pH of its water extract neutral or somewhat acidic.

### Example 6

### Reactivity Issue on Lab Extruder Experiments

Six lab scale polymerization experiments (Runs 1 through 6) were conducted over the course of a week's time. The oligomer mixture for Run 1 was formulated in first tank (i.e. tank 1) and Run 1 did not show any reactivity issues. The oligomer mixture for Run 2 with an identical composition was formulated in a second tank (i.e. tank 2) and Run 2 did not show expected Mw build. Runs 3, 4, and 5 (with oligomer mixture having other compositions) required much more catalyst than expected which indicated that there was a reactivity problem (see table 11).

TABLE 11
results

| | | Monomer | Expected | Required | Expected PC | |
|---|---|---|---|---|---|---|
| Run # | Composition | Tank # | alpha-cat (eq) | alpha-cat (eq) | Mw (avg) | PC Mw (avg) |
| 1 | BPA/PPP-BP/Pluronics | 1 | 6 | 6 | 27000 | 26998 |
| 2 | BPA/PPP-BP/Pluronics | 2 | 6 | 8 | 27000 | No Mw Build |
| 3 | MeHQ/HQ/BPA/PPP-BP | 1 | 10 | 17 | 22000 | 21947 |
| 4 | MeHQ/HQ/PPP-BP | 2 | 10 | 19 | 22000 | 19044 |
| 5 | MeHQ/HQ/PPP-BP | 1 | 10 | 13 | 22000 | 19655 |
| 6 | BPA/PPP-BP/Pluronics | 1 | 6 | 6 | 27000 | 27436 |

In the beginning of the week the catalyst solution preparation and later the catalyst stock solutions were suspected. Both were checked by means of an acidibase titration and found to be within tolerable limits (see table 12). Also the pH of the used raw materials was measured and also found to be acceptable (see table 13).

TABLE 12
titration results

| | | HCL (aq) | | stock solution (aq) | | Avg.conc. | STDEV |
|---|---|---|---|---|---|---|---|
| Solution | titration | V (ml) | Conc (mol/l) | V (ml) | Conc (mol/l) | (mol/l) | — |
| Old (0.5M) | 1 | 4.98 | 1 | 10 | 0.498 | 0.487 | 0.010 |
| NaOH stock | 2 | 4.78 | 1 | 10 | 0.478 | | |
| solution | 3 | 4.86 | 1 | 10 | 0.486 | | |
| New (0.5M) | 1 | 5.09 | 1 | 10 | 0.509 | 0.504 | 0.023 |
| NaOH stock | 2 | 4.79 | 1 | 10 | 0.479 | | |
| solution | 3 | 5.25 | 1 | 10 | 0.525 | | |
| | | | | | | Conc (g/l) | Conc (%) |
| 25% TMAH | 1 | 3.40 | 1 | 10 | 3.40 | 310 | 31 |
| stock solution | | | | | | | |

TABLE 13
pH measurement results

| Monomer | pH |
|---|---|
| PPP-BP | 6.91 |
| MeHQ | 5.95 |
| HQ | 5.15 |

Based on these results it was believed that some other acidic system contamination was present that quenched the polymerization catalyst. The acidic system contamination was contemplated to be salicylic acid formed by contact of BMSC, water, and caustic. These components were used in formulation tank 2 during a test with a jet solutions mixer and were likely not completely removed by the cleaning process.

As can be seen in FIG. 5, the cause of the reactivity problems is salicylic acid. LC-MS analysis confirmed that the MS sample (line 4) collected during the third run contained approximately 20 ppm salicylic acid. A MS sample (line 3 on FIG. 5) collected during the first run of the week did not contain detectable levels of salicylic acid. Two oligomer samples (lines 1 and 2 respectively) were analyzed from these same runs (1 and 3 on FIG. 5) but no Salicylic acid was found.

Together with the MS the salicylic acid was removed from the polymer in the extruder and collected in a MS collection tank. This MS/salicylic acid mixture was then used to clean the formulation tanks and in this process the formulation tanks were believed to be contaminated.

After Run 5 the formulation tanks and extruder feed line were extensively cleaned with a MS/TMAH solution followed by a cleaning with MS only. After the cleaning process a repeat of run 2 (Run 6) was conducted without any reactivity issues thereby confirming removal of the salicylic acid from the system.

1. A method of preparing polycarbonate comprising the steps of:
(a) providing a first ester substituted diaryl carbonate mixture comprising an ester substituted diaryl carbonate, wherein said first ester substituted diaryl carbonate mixture may contain acid-substituted phenol,
(b) treating the first ester substituted diaryl carbonate mixture to reduce the level of acid-substituted phenol, if present, to an amount of less than 100 ppm, thereby creating a second ester substituted diaryl carbonate mixture,
(c) forming a melt reaction mixture comprising the second ester substituted diaryl carbonate mixture, a dihydroxy compound, and a melt transesterification catalyst,
(d) allowing the melt reaction mixture to react to build molecular weight, thereby preparing polycarbonate.

2. The method of claim 1, wherein step (b) is performed such that acid-substituted phenol is present in an amount of less than 70 ppm.

3. The method of claim 2, wherein step (b) is performed such that acid-substituted phenol is present in an amount of less than 50 ppm.

4. The method of claim 3, wherein step (b) is performed such that acid-substituted phenol is present in an amount of less than 10 ppm.

5. The method of claim 4, wherein step (b) is performed such that acid-substituted phenol is present in an amount of less than 5 ppm.

6. The method of claim 1, wherein the melt reaction mixture has a molar ratio (acid-substituted phenol to melt transesterification catalyst) of less than 10/1.

7. The method of claim 6, wherein the melt reaction mixture has a molar ratio (acid-substituted phenol to melt transesterification catalyst) of less than 5/1.

8. The method of claim 1, further comprising the step performed after step (b) of controlling contact of the second ester substituted diaryl carbonate mixture with water, transesterification catalyst, and heat, such that the amount of acid-substituted phenol present in the second ester substituted diaryl carbonate mixture is maintained at less than 100 ppm until formation of the melt reaction mixture.

9. The method of claim 8, where the step of controlling contact of the second ester substituted diaryl carbonate mixture with water, transesterification catalyst, and/or heat, is accomplished by preventing the second ester substituted diaryl carbonate mixture from coming in contact with water.

10. The method of claim 8, where the step of controlling contact of the second ester substituted diaryl carbonate mixture with water, transesterification catalyst, and/or heat, is accomplished by preventing the second ester substituted diaryl carbonate mixture from coming in contact with transesterification catalyst.

11. The method of claim 1, wherein the ester substituted diaryl carbonate mixture comprises bismethylsalicylcarbonate and the acid-substituted phenol is salicylic acid.

12. A method of preparing polycarbonate comprising the steps of:
(a) forming a melt reaction mixture comprising an ester substituted diaryl carbonate mixture, a dihydroxy compound, and a melt transesterification catalyst, wherein:
the ester substituted diaryl carbonate mixture may contain acid-substituted phenol and is:
(i) tested for the presence of said acid-substituted phenol prior to forming the melt reaction mixture, and
(ii) if said acid-substituted phenol is present, treated to reduce the level of said acid-substituted phenol to an amount of less than 100 ppm,
(b) allowing the melt reaction mixture to react to build molecular weight, thereby preparing a polycarbonate.

13. The method of claim 12, wherein the melt reaction mixture has a molar ratio (acid-substituted phenol/catalyst) of less than 10/1.

14. The method of claim 12, further comprising the step of controlling contact of the ester substituted diaryl carbonate mixture with water, transesterification catalyst, and heat, prior to the formation of the melt reaction mixture such that the amount of acid-substituted phenol present in the ester substituted diaryl carbonate mixture is maintained at less than 100 ppm until formation of the melt reaction mixture.

15. The method of claim 14, where the step of controlling contact of the ester substituted diaryl carbonate mixture with water, transesterification catalyst, and heat, is accomplished by preventing the ester substituted diaryl carbonate mixture from coming in contact with water.

16. The method of claim 14, where the step of controlling contact of the ester substituted diaryl carbonate mixture with water, transesterification catalyst, and heat, is accomplished by preventing the ester substituted diaryl carbonate mixture from coming in contact with transesterification catalyst.

17. The method of claim 12, wherein ester substituted diaryl carbonate mixture is tested for the presence of the acid-substituted phenol and treated, if necessary, prior to the addition of the melt transesterification catalyst.

18. The method of claim 12, wherein ester substituted diaryl carbonate mixture is tested for the presence of the acid-substituted phenol and treated, if necessary, after to the addition of the melt transesterification catalyst to form the melt reaction mixture.

19. A method of preparing polycarbonate comprising the steps of:
(a) forming a melt reaction mixture comprising a dihydroxy compound, an ester substituted diaryl carbonate mixture, and a melt transesterification catalyst, wherein the ester substituted diaryl carbonate mixture may contain acid-substituted phenol,
(b) determining the amount of acid-substituted phenol present in the melt reaction mixture and adjusting the molar ratio of acid-substituted phenol to melt transesterification catalyst (acid-substituted phenol/catalyst) in the melt reaction mixture to an amount of less than 10, and
(c) allowing the melt reaction mixture to react to build molecular weight, thereby preparing polycarbonate.

20. The method of claim 19, wherein the step of:
adjusting the molar ratio of acid-substituted phenol, if present, to melt transesterification catalyst (acid-substituted phenol/catalyst) in the melt reaction mixture to an amount of less than 10, and
occurs such that the molar ratio of acid-substituted phenol to melt transesterification catalyst is reduced to a molar ratio (acid-substituted phenol/catalyst) of less than 5.

21. The method of claim 20, wherein the molar ratio of acid-substituted phenol to melt transesterification catalyst is reduced to a molar ratio (acid-substituted phenol/catalyst) of less than 2.

22. The method of claim 21, wherein the molar ratio of acid-substituted phenol to melt transesterification catalyst is reduced to a molar ratio (acid-substituted phenol/catalyst) of less than 1.1/1.

23. The method of claim 19, wherein the step of:
(b) adjusting the molar ratio of acid-substituted phenol, if present, to melt transesterification catalyst (acid-substituted phenol/catalyst) in the melt reaction mixture to an amount of less than 10,
is accomplished by:
increasing the temperature of the melt reaction mixture to thermally degrade or devolatize the acid-substituted phenol.

24. The method of claim 19, wherein the step of:
adjusting the molar ratio of acid-substituted phenol, if present, to melt transesterification catalyst (acid-substituted phenol/catalyst) in the melt reaction mixture to an amount of less than 10,
is accomplished by:
increasing the amount of melt transesterification catalyst in the melt reaction mixture.

25. The method of claim 19, wherein the step of:
adjusting the molar ratio of acid-substituted phenol, if present, to melt transesterification catalyst (acid-substituted phenol/catalyst) in the melt reaction mixture to an amount of less than 10,
occurs prior to forming the melt reaction mixture.

26. The method of claim 25, wherein the step of:
adjusting the molar ratio of acid-substituted phenol, if present, to melt transesterification catalyst (acid-substituted phenol/catalyst) in the melt reaction mixture to an amount of less than 10, and
is accomplished by:
(i) treating the ester substituted diaryl carbonate mixture to reduce the level of said acid-substituted phenol, if present, to an amount of less than 100 ppm prior to forming the melt reaction mixture.

27. A method of preparing an ester substituted diaryl carbonate mixture suitable for use in a melt polymerization reaction, the method comprising the steps of:
(a) providing an initial ester substituted diaryl carbonate mixture comprising an ester substituted diaryl carbonate, wherein said initial ester substituted diaryl carbonate mixture contains acid-substituted phenol, if at all, in an amount less than 100 ppm,
(b) adjusting, if necessary the pH of the initial ester substituted diaryl carbonate mixture to a pH of less than 11, and
(c) controlling contact of the ester substituted diaryl carbonate mixture with water, transesterification catalyst, and/or heat,
whereby the amount of acid-substituted phenol present in the ester substituted diaryl carbonate mixture is maintained in an amount less than 100 ppm, thereby preparing an ester substituted diaryl carbonate mixture suitable for use in a melt polymerization reaction.

28. The method of claim 27, wherein in step (c) contact of the ester substituted diaryl carbonate mixture with water is controlled.

29. The method of claim 28, wherein contact with water is controlled by a method comprising adding a water scavenging agent to the ester substituted diaryl carbonate mixture.

30. The method of claim 27, wherein in step (c) contact of the ester substituted diaryl carbonate mixture with transesterification catalyst is controlled.

31. The method of claim 30, wherein contact with transesterification catalyst is controlled by adding an acid stabilizer to the ester substituted diaryl carbonate mixture.

32. The method of claim 31, wherein the acid stabilizer is a phosphorus or sulfur based acid.

33. The method of claim 27, further comprising the step of: (d) treating the ester substituted diaryl carbonate mixture to reduce the level of acid-substituted phenol, if present, to an amount of less than 70 ppm, thereby creating a second ester substituted diaryl carbonate mixture.

34. The method of claim 27, wherein step (b) is performed if necessary such that the pH of the initial ester substituted diaryl carbonate mixture is adjusted to a pH of less than 10.

35. The method of claim 34, wherein step (b) is performed if necessary such that the pH of the initial ester substituted diaryl carbonate mixture is adjusted to a pH of less than 8.
